(19) United States
(12) Patent Application Publication
(10) Pub. No.: US 2025/0164679 A1
(43) Pub. Date: May 22, 2025

(54) OPTICAL FILTER, LIGHT ABSORBING COMPOSITION, METHOD FOR PRODUCING OPTICAL FILTER, SENSING DEVICE AND SENSING METHOD

(71) Applicant: Nippon Sheet Glass Company, Limited, Tokyo (JP)

(72) Inventors: Yuichiro KUBO, Tokyo (JP); Kazuaki OYA, Hyogo (JP); Daisuke TSUJI, Aichi (JP)

(21) Appl. No.: 18/840,402

(22) PCT Filed: Feb. 16, 2023
(86) PCT No.: PCT/JP2023/005580

§ 371 Date: Aug. 21, 2024

(30) Foreign Application Priority Data
Feb. 22, 2022 (JP) 2022-026018

(51) Int. Cl. G02B 5/22

(52) U.S. Cl. CPC G02B 5/22

(57) ABSTRACT

Provided is an optical filter (1a) including a light-absorbing compound and a resin including the light-absorbing compound. The optical filter (1a) has a first transmission spectrum satisfying the following requirements (i), (ii), (iii), and (iv). An absolute value |λ_{1-UV}^{25° C.}−λ_{2-UV}^{25° C.}| is 8 nm or less. (i) An average transmittance in a wavelength range of 300 nm to 380 nm is 1% or less. (ii) An average transmittance in a wavelength range of 450 nm to 600 nm is 80% or more. (iii) An average transmittance in a wavelength range of 700 nm to 725 nm is 10% or less. (iv) An average transmittance in a wavelength range of 950 nm to 1150 nm is 5% or less.

### TECHNICAL FIELD

The present invention relates to an optical filter, a light-absorbing composition, a method for manufacturing an optical filter, a sensing apparatus, and a sensing method.

### BACKGROUND ART

In imaging apparatuses employing a solid-state image sensing device such as a charge coupled device (CCD) or a complementary metal oxide semiconductor (CMOS), any of various optical filters is placed in front of the solid-state image sensing device in order to obtain images with good color reproduction. Solid-state image sensing devices generally have spectral sensitivity over a wide wavelength range from the ultraviolet to infrared regions. On the other hand, the visual sensitivity of humans lies solely in a visible region. Thus, a technique is known in which an optical filter blocking a portion of infrared light or ultraviolet light is placed in front of a solid-state image sensing device in an imaging apparatus in order to allow the spectral sensitivity of the solid-state image sensing device to approximate to the visual sensitivity of humans.

It has been common for such an optical filter to block infrared or ultraviolet by means of light reflection by a dielectric multilayer film. In recent years, optical filters including a light absorbent-including film have been attracting attention. The transmittance properties of optical filters including a light-absorbent-including film are unlikely to be dependent on the incident angle, and this makes it possible to obtain favorable images with less color change, less color unevenness in-plane, and high reproducibility even when light is obliquely incident on the optical filters in imaging apparatuses. Moreover, light-absorbing type optical filters not including a light-reflecting film allow good images to be easily obtained in a backlit or nightscape condition because such optical filters can reduce occurrence of ghosting and flare caused by multiple reflection in the light-reflecting film. Moreover, optical filters including a layer including a light absorbent are advantageous also in terms of reducing the size and thickness of imaging apparatuses.

For example, optical filters including a layer including a light absorbent formed from a phosphonic acid and a copper ion are known as optical filters for such use. For example, Patent Literature 1 describes an optical filter including a UV-IR absorbing layer capable of absorbing infrared light and ultraviolet light. The UV-IR absorbing layer includes a UV-IR absorbent formed from a phosphonic acid and a copper ion. A UV-IR absorbing composition includes, for example, a phenyl-based phosphonic acid and an alkyl-based phosphonic acid so that the optical filter will satisfy predetermined optical properties.

Patent Literature 2 describes an optical filter including a light-absorbing layer including a copper phosphonate and an organic dye.

### CITATION LIST

### Patent Literature

Patent Literature 1: JP 6232161 B1

Patent Literature 2: JP 6709885 B1

### SUMMARY OF INVENTION

### Technical Problem

From the viewpoint of increasing the yield of products including an optical filter, the techniques described in Patent Literatures 1 and 2 leave room for reexamination. Therefore, the present invention provides an optical filter that is advantageous from the viewpoint of increasing the yield of products including the optical filter.

### Solution to Problem

The present invention provides an optical filter including:
a light-absorbing compound; and
a resin,
wherein the optical filter has a first transmission spectrum at an incident angle of 0° at 25° C. before a heating test in which the optical filter is heated at 125° C. for 200 hours, the first transmission spectrum satisfying the following requirements (i), (ii), (iii), and (iv),
wherein the optical filter has a second transmission spectrum at an incident angle of 0° at 25° C. after the heating test, and
wherein an absolute value of a difference between a wavelength λ_{1-UV}^{25° C.} which lies in a wavelength range of 350 nm to 450 nm and at which a transmittance is 50% in the first transmission spectrum and a wavelength λ_{2-UV}^{25° C.} which lies in the wavelength range of 350 nm to 450 nm and at which the transmittance is 50% in the second transmission spectrum is 8 nm or less:
(i) an average transmittance in a wavelength range of 300 nm to 380 nm is 1% or less;
(ii) an average transmittance in a wavelength range of 450 nm to 600 nm is 80% or more;
(iii) an average transmittance in a wavelength range of 700 nm to 725 nm is 10% or less; and
(iv) an average transmittance in a wavelength range of 950 nm to 1150 nm is 5% or less.

The present invention also provides a light-absorbing composition including:
a light-absorbing compound;
a curable resin;
at least one selected from the group consisting of an alkoxysilane and a hydrolysate of an alkoxysilane; and
water.

The present invention also provides a method for manufacturing an optical filter, including causing the above light-absorbing composition to have the curable resin cured by a step including the following heating steps (a), (b), (c), and (d):
(a) heating at a first heating temperature included in a temperature range of room temperature to 60° C. for 2 hours or more;
(b) heating at a second heating temperature included in a temperature range of the first heating temperature to 100° C. for 2 hours or more;
(c) heating at a third heating temperature included in a temperature range of the second heating temperature to 140° C. for 2 hours or more; and
(d) heating at a fourth heating temperature included in a temperature range of the third heating temperature to 200° C. for 1 hour or more.

The present invention also provides an imaging apparatus including the above optical filter.

The present invention also provides a sensing apparatus including:
an imaging apparatus; and
a computer connected to the imaging apparatus,
wherein the imaging apparatus includes the above optical filter.

The present invention also provides a sensing method including executing, by a computer, given processing on image data obtained by an imaging apparatus, wherein the imaging apparatus includes the above optical filter.

### Advantageous Effects of Invention

The above optical filter is advantageous from the viewpoint of increasing the yield of products including the optical filter.

### BRIEF DESCRIPTION OF DRAWINGS

FIG. 1A is a cross-sectional view showing an example of an optical film according to the present invention.

FIG. 1B is a cross-sectional view showing another example of the optical film according to the present invention.

FIG. 1C is a cross-sectional view showing yet another example of the optical film according to the present invention.

FIG. 1D is a cross-sectional view showing yet another example of the optical film according to the present invention.

FIG. 2A is a cross-sectional view schematically showing an example of an imaging apparatus according to the present invention.

FIG. 2B is a cross-sectional view schematically showing another example of the imaging apparatus according to the present invention.

FIG. 3 is a diagram schematically showing an automobile including the imaging apparatus according to the present invention.

FIG. 4 is a block diagram showing an example of a sensing apparatus according to the present invention.

FIG. 5 is a graph showing transmission spectra of an optical filter according to Example 1.

FIG. 6 is a graph showing transmission spectra of an optical filter according to Example 4.

FIG. 7 is a graph showing transmission spectra of an optical filter according to Example 5.

FIG. 8 is a graph showing transmission spectra of the optical filter according to Example 1 at an incident angle of 0° at 25° C. and 70° C.

FIG. 9 is a graph showing a reflection spectrum of the optical filter according to Example 1.

FIG. 10 is a graph showing a reflection spectrum of the optical filter according to Example 4.

FIG. 11 is a graph showing a reflection spectrum of the optical filter according to Example 5.

FIG. 12 is a graph showing transmission spectra of the optical filter according to Example 1 before and after a heating test.

FIG. 13 is a graph showing transmission spectra of the optical filter according to Example 4 before and after a heating test.

FIG. 14 is a graph showing transmission spectra of an optical filter according to Comparative Example 2 before and after a heating test.

FIG. 15 is a graph showing transmission spectra of an optical filter according to Comparative Example 3 before and after a heating test.

### DESCRIPTION OF EMBODIMENTS

Placing an optical filter blocking a portion of incident light in a given environment may decrease the yield of products including the optical filter. For example, when a screening test involving heating is performed on component members of optical systems such as optical filters or products including an optical filter, the yield of the products including the optical filter may decrease depending on the conditions of the screening test such as heating conditions. Here, the screening test is not limited to a particular test. The screening test can be, for example, a test performed at the time of design of a product including an optical filter to examine whether or not the optical filter has required heat resistance. The screening test may be a test performed to screen out an optical filter having an initial failure or a potential defect before shipment of the optical filter. The screening test may be a test performed to screen out an optical filter having an initial failure or a potential defect before the optical filter is put into a manufacturing process for a product in which the optical filter is to be installed. The screening test may be a test performed to screen out a product having an initial failure or a potential defect before shipment of the product in which the optical filter is installed. The screening test includes an inspection act in which determination of conformance or nonconformance, determination of acceptance or rejection, or determination of a non-defective article or a defective article is made in comparison with a given criterion. The type and conditions of the screening test are appropriately determined in accordance with required durability or heat resistance. In consideration of manufacturing business conditions, it is desirable that the screening test be completed in a short period of time for determination. The screening test may be, for example, a thermal cycle test performed under a condition of an upper limit temperature of 60° C. to 120° C. and a lower limit temperature of −40° C. to 5° C., or a heat shock test (thermal shock test) involving an abrupt temperature change. From the viewpoint of whether or not a certain product has given heat resistance, the screening test may be a heating test. Examples of the conditions of the heating test can include a condition in which the maintenance time of an upper limit temperature of 80° C. to 200° C. is from 5 minutes to several hours. It is desirable to determine the conformance or nonconformance by the heating test under such a condition. For example, when the optical filter is intended to be installed on an electronic substrate, the upper limit temperature of the heating test can be determined in consideration of an upper limit temperature (for example, 260° C.) of soldering to be used for manufacturing the electronic substrate. The heating test may be a test in which an optical filter to be tested is left to stand inside a constant-temperature chamber at room temperature, the temperature inside the constant-temperature chamber is increased, for example, until the temperature reaches a target temperature, such as 125° C., the temperature is maintained at the target temperature for a given period of time (for example, 200 hours), and then the temperature is decreased to room temperature.

As a product including an optical filter, for example, an imaging apparatus such as an vehicle-mounted camera is expected. The vehicle-mounted camera is installed, for example, in vehicles such as an automobile and a train. The vehicle-mounted camera takes an image of, for example, situations in the periphery of the own vehicle, such as a traffic situation, presence or absence of an obstacle, and a clearance from another vehicle, or a situation inside the vehicle. The vehicle-mounted camera is used to take an image for the purpose of, for example, displaying the inside or outside of the vehicle on a display or the like, recording the image on a storage device, inputting the image to a computer for image sensing, analyzing the image, and processing and utilizing data. It is also expected that an automobile be used, for example, in a region having a relatively high temperature, such as the Middle East region. In addition, in a hot weather environment, a temperature inside the vehicle may be extremely high. Heat resistance is thus required of each part of the vehicle-mounted camera installed in the vehicle such as the automobile. Therefore, in some cases, a screening test is performed on the optical filter to be used in the vehicle-mounted camera before installation in a module or the like. The vehicle-mounted camera also includes a camera that is intended to be brought into a vehicle and used inside the vehicle. The screening test includes, for example, exposure to a high-temperature environment or an accelerated test in order to ensure the heat resistance of the optical filter. In the vehicle-mounted camera, only a part that has passed such a heat-resistance-related test can be incorporated in a camera module or the like as a conforming article (non-defective article). Meanwhile, a part, such as an optical filter, that has not passed the required heat-resistance-related test is removed from an assembly process and disposed of as a non-conforming article, a defective article, a rejected article, or the like. Therefore, the larger number of nonconforming articles, defective articles, or rejected articles lead to a decrease in yield relating to a screening test relating to the heat resistance of optical filters or an inspection for whether or not the heat resistance is satisfied, and an increase in manufacturing cost, directly resulting in a deterioration in profits. Accordingly, there tends to be a strong demand for an optical filter having the performance of heat resistance exceeding a threshold or a criterion.

The present inventors have made extensive investigations from the viewpoints of providing an optical filter having sufficient heat resistance and also increasing the yield of products including an optical filter such as an vehicle-mounted camera. A lot of trial and error has resulted in finding that a given optical filter utilizing light absorption has given heat resistance and is advantageous from the viewpoint of increasing the yield of products, and thus the present invention has been completed.

Embodiments of the present invention will be described hereinafter. The following description relates to examples of the present invention, and the present invention is not limited to the embodiments given below.

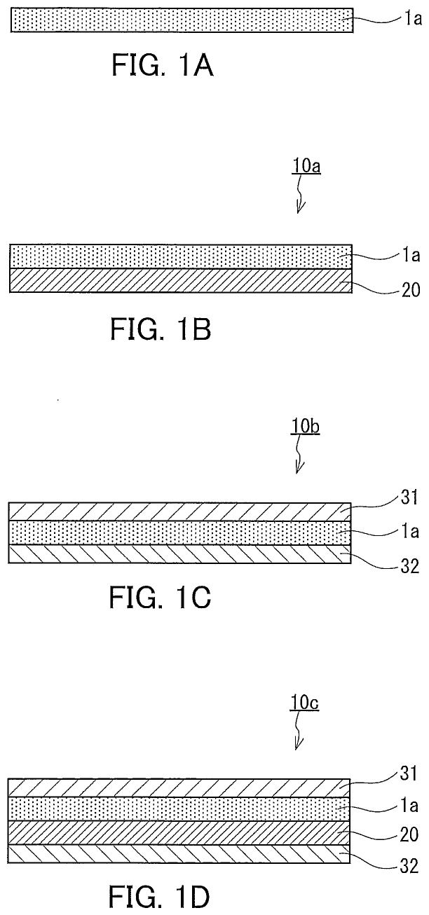

FIG. 1A is a cross-sectional view showing an optical filter 1a. The optical filter 1a includes a light-absorbing compound and a resin including the light-absorbing compound. The optical filter 1a absorbs light in a given wavelength range. The optical filter 1a has a first transmission spectrum satisfying the following requirements (i), (ii), (iii), and (iv) when light with a wavelength of 300 nm to 1200 nm is allowed to be incident on the optical filter 1a at an incident angle of 0° at 25° C. This makes it possible to block light belonging to a portion of ultraviolet light and infrared light, and, for example, in an imaging apparatus including the optical filter 1a, an image can be obtained from light generally belonging to a visible region. The first transmission spectrum is a transmission spectrum obtained by measuring the optical filter 1a before a heating test in which heating is performed at 125° C. for 200 hours.
(i) An average transmittance in a wavelength range of 300 nm to 380 nm is 1% or less
(ii) An average transmittance in a wavelength range of 450 nm to 600 nm is 80% or more
(iii) An average transmittance in a wavelength range of 700 nm to 725 nm is 10% or less
(iv) An average transmittance in a wavelength range of 950 nm to 1150 nm is 5% or less

As for the requirement (i), the average transmittance in the wavelength range of 300 nm to 380 nm is desirably 0.8% or less, more desirably 0.6% or less, even more desirably 0.4% or less, and particularly desirably 0.2% or less in the first transmission spectrum. Light with a wavelength of 300 nm to 380 nm belongs to a portion of ultraviolet light. Such light is difficult to recognize by human eyes, and it is advantageous for the optical filter, except in certain fields, to have a low transmittance in this wavelength range and a high blocking property against light in this wavelength range.

As for the requirement (ii), the average transmittance in the wavelength range of 450 nm to 600 nm is desirably 82% or more, and more desirably 85% or more in the first transmission spectrum. This wavelength belongs to the visible region (380 nm to 780nm), and sensitivity (visual sensitivity) of human eyes to light in this wavelength range is relatively high. Thus, human eyes can recognize brightness of the light in this wavelength range, and thus it is advantageous for the optical filter to have a high transmittance in this wavelength range.

As for the requirement (iii), the average transmittance in the wavelength range of 700 nm to 725 nm is desirably 8% or less, more desirably 6% or less, and even more desirably 4% or less in the first transmission spectrum. This wavelength corresponds to a wavelength exhibiting a red color. The red color is recognized more brightly by human eyes than other primary colors such as a blue color and a green color, and thus it is advantageous for the optical filter to have a low transmittance in this wavelength range.

As for the requirement (iv), the average transmittance in the wavelength range of 950 nm to 1150 nm is desirably 4% or less, more desirably 2% or less, and even more desirably 1% or less in the first transmission spectrum. A solid-state image sensing device such as a CMOS or a CCD used in an imaging apparatus includes a semiconductor such as silicon. Therefore, the solid-state image sensing device can have given sensitivity in the wavelength range extending to 1150 nm, the wavelength range being unrecognizable to human eyes. It is therefore advantageous for the optical filter to have a sufficiently low transmittance in this wavelength range.

An average transmittance in the wavelength range of 900 nm to 950 nm in the first transmission spectrum is not limited to a particular value. The average is, for example, 5% or less, desirably 3% or less, more desirably 1% or less, even more desirably 0.5% or less, and particularly desirably 0.1% or less. For example, light including wavelengths such as 905 nm and 940 nm is emitted as reference light in sensing of a position using a laser. Light with such a wavelength can be reflected by a measurement object, and reflected light can be received for sensing. It is therefore advantageous for the optical filter to have a sufficiently low transmittance in a range including a wavelength corresponding to the reference light.

The optical filter 1a has a second transmission spectrum when light with a wavelength of 300 nm to 1200 nm is allowed to be incident on the optical filter 1a at an incident angle of 0° at 25° C. after the above heating test. In the optical filter 1a, an absolute value |λ_{1-UV}^{25° C.}-λ_{2-UV}^{25° C.}| of a difference between a wavelength λ_{1-UV}^{25° C.} and a wavelength λ_{2-UV}^{25° C.} is, for example, 8 nm or less. The wavelength λ_{1-UV}^{25° C.} is a wavelength which lies in the wavelength range of 350 nm to 450 nm and at which the transmittance is 50% in the first transmission spectrum. The wavelength λ_{2-UV}^{25° C.} is a wavelength which lies in the wavelength range of 350 nm to 450 nm and at which the transmittance is 50% in the second transmission spectrum. As the absolute value |λ_{1-UV}^{25° C.}-λ_{2-UV}^{25° C.}| is 8 nm or less, a wavelength which lies in the wavelength range of 350 nm to 450 nm and at which the transmittance is 50% is unlikely to vary before and after the heating test. Therefore, for example, even when a screening test involving heating is performed on the optical filter 1a, a yield of products including the optical filter is unlikely to decrease. Moreover, the heating test may be one in which the optical filter 1a is left to stand inside a constant-temperature chamber at room temperature, the temperature inside the constant-temperature chamber is increased until the temperature reaches 125° C., the temperature is maintained at 125° C. for 200 hours, and then the temperature is allowed to naturally decrease to room temperature. The temperature of the optical filter 1a may be increased by putting the optical filter 1a into the constant-temperature chamber maintained at 125° C. in advance. The temperature of the optical filter 1a may be decreased by taking out the optical filter 1a from the inside of the constant-temperature chamber in which the internal temperature is in a high temperature state after the temperature inside the constant-temperature chamber has been maintained at 125° C. for 200 hours and naturally lowering the temperature outside the constant-temperature chamber. It is noted that when these operations are performed, a thermal shock element is added to the optical filter 1a. In the heating test, the humidity inside the constant-temperature chamber may be left to take its own course. Specifically, the humidity inside the constant-temperature chamber may conform to the humidity inside a room maintained at a humidity of 40% to 60%. The humidity inside the constant-temperature chamber during the heating test may be 40% to 60%. Moreover, in some cases, a heating test is performed on an optical filter distributed in the market. As long as the gist of the present application is satisfied, it is not a problem whether the optical filter was subjected to the same or another heating test in the past. It suffices that the gist of the present application is satisfied when a heating test is performed newly or for the first time on the optical filter distributed in the market.

The wavelength λ_{1-UV}^{25° C.} is not limited to a particular value as long as the wavelength λ_{1-UV}^{25° C.} belongs to the wavelength range of 350 nm to 450 nm. The wavelength λ_{1-UV}^{25° C.} is a wavelength corresponding to a lower limit of a wavelength region of light that is recognizable to human eyes. From the viewpoint of consistency with or similarity to the visual sensitivity properties of humans, it is advantageous that the wavelength λ_{1-UV}^{25° C.} belongs to such a range. The wavelength λ_{1-UV}^{25° C.} is, for example, 390 nm to 450 nm, desirably 395 nm to 445 nm, and more desirably 400 nm to 440 nm.

The absolute value |λ_{1-UV}^{25° C.}-λ_{2-UV}^{25° C.}| is desirably 7 nm or less, more desirably 6 nm or less, and even more desirably 5 nm or less.

In the optical filter 1a, an absolute value |λ_{1-IR}^{25° C.}-λ_{2-IR}^{25° C.}| of a difference between a wavelength λ_{1-IR}^{25° C.} and a wavelength λ_{2-IR}^{25° C.} is not limited to a particular value. The wavelength λ_{1-IR}^{25° C.} is a wavelength which lies in the wavelength range of 600 nm to 700 nm and at which the transmittance is 50% in the first transmission spectrum. The wavelength λ_{2-IR}^{25° C.} is a wavelength which lies in the wavelength range of 600 nm to 700 nm and at which the transmittance is 50% in the second transmission spectrum. The absolute value |λ_{1-IR}^{25° C.}-λ_{2-IR}^{25° C.}| is, for example, 5 nm or less. In this case, a wavelength which lies in the wavelength range of 600 nm to 700 nm and at which the transmittance is 50% is unlikely to vary before and after the heating test. Therefore, for example, even when a screening test involving heating is performed on the optical filter 1a, a yield of products including the optical filter is more unlikely to decrease.

The absolute value |λ_{1-IR}^{25° C.}-λ_{2-IR}^{25° C.}| is desirably 4 nm or less, and more desirably 3 nm or less.

The wavelength λ_{1-IR}^{25° C.} is not limited to a particular value as long as the wavelength λ_{1-IR}^{25° C.} belongs to the wavelength range of 600 nm to 700 nm. The wavelength λ_{1-IR}^{25° C.} is a wavelength corresponding to an upper limit of a wavelength region of light that is recognizable to human eyes. From the viewpoint of consistency with or similarity to the visual sensitivity properties of humans, it is advantageous that the wavelength λ_{1-IR}^{25° C.} belongs to such a range. The wavelength λ_{1-IR}^{25° C.} is, for example, 610 nm to 690 nm, desirably 615 nm to 685 nm, and more desirably 620 nm to 680 nm.

In the optical filter 1a, an absolute value |λ₁₋₂₀^{25° C.}-λ₂₋₂₀^{25° C.}| of a difference between a wavelength λ₁₋₂₀^{25° C.} and a wavelength λ₂₋₂₀^{25° C.} is not limited to a particular value. The wavelength λ₁₋₂₀^{25° C.} is a wavelength which lies in the wavelength range of 600 nm to 700 nm and at which the transmittance is 20% in the first transmission spectrum. The wavelength λ₂₋₂₀^{25° C.} is a wavelength which lies in the wavelength range of 600 nm to 700 nm and at which the transmittance is 20% in the second transmission spectrum. The absolute value |λ₁₋₂₀^{25° C.}-λ₂₋₂₀^{25° C.}| is, for example, 5 nm or less. In this case, a wavelength which lies in the wavelength range of 600 nm to 700 nm and at which the transmittance is 20% is unlikely to vary before and after the heating test. Therefore, for example, even when a screening test involving heating is performed on the optical filter 1a, a yield of products including the optical filter 1a is more unlikely to decrease. Moreover, steepness of the transmission spectrum increases at or near the wavelength which lies in the wavelength range of 600 nm to 700 nm and at which the transmittance is 20%, and thus the absolute value |λ₁₋₂₀^{25° C.}-λ₂₋₂₀^{25° C.}| is set to a particular value or less, thereby making it difficult to sense a variation in the transmission spectrum.

The absolute value |λ₁₋₂₀^{25° C.}-λ₂₋₂₀^{25° C.}| is desirably 4 nm or less, and more desirably 3 nm or less.

In the optical filter 1a, an absolute value |T₁₋₄₅₀^{25° C.}-T₂₋₄₅₀^{25° C.}| of a difference between an average T₁₋₄₅₀^{25° C.} and an average T₂₋₄₅₀^{25° C.} is not limited to a particular value. The average T₁₋₄₅₀^{25° C.} is an average transmittance in the wavelength range of 400 nm to 450 nm in the first transmission spectrum. The average T₂₋₄₅₀^{25° C.} is an average transmittance in the wavelength range of 400 nm to 450 nm in the second transmission spectrum. The absolute value |T₁₋₄₅₀^{25° C.}-T₂₋₄₅₀^{25° C.}| is, for example, 8% or less. In this case, an average transmittance in the wavelength range of 400 nm to 450 nm is unlikely to vary before and after the heating test. Therefore, for example, even when a screening test involving heating is performed on the optical filter 1a, a yield of products including the optical filter 1a is more unlikely to decrease.

The absolute value |T₁₋₄₅₀^{25° C.}-T₂₋₄₅₀^{25° C.}| is desirably 7% or less, and more desirably 6% or less.

In the optical filter 1a, an absolute value |T_{1-VIS}^{25° C.}-T_{2-VIS}^{25° C.}| of a difference between an average T_{1-VIS}^{25° C.} and an average T_{2-VIS}^{25° C.} is not limited to a particular value. The average T_{1-VIS}^{25° C.} is an average transmittance in the wavelength range of 450 nm to 600 nm in the first transmission spectrum. The average T_{2-VIS}^{25° C.} is an average transmittance in the wavelength range of 450 nm to 600 nm in the second transmission spectrum. The absolute value |T_{1-VIS}^{25° C.}-T_{2-VIS}^{25° C.}| is, for example, 3% or less. In this case, an average transmittance in the wavelength range of 450 nm to 600nm is unlikely to vary before and after the heating test, and a change in brightness of an image acquired through the optical filter 1a is perceived small. Therefore, for example, even when a screening test involving heating is performed on the optical filter 1a, a yield of products including the optical filter 1a is more unlikely to decrease.

The absolute value |T_{1-VIS}^{25° C.}-T_{2-VIS}^{25° C.}| is desirably 2.5% or less, and more desirably 2% or less.

The second transmission spectrum may satisfy requirements for the first transmission spectrum, such as the above requirements (i), (ii), (iii), and (iv). The above requirements (i), (ii), (iii), and (iv) require that the spectrum of the optical filter have satisfactory conformance to the visual sensitivity of a human. The fact that the above requirements (i), (ii), (iii), and (iv) are satisfied even after the heating test indicates that the optical filter can maintain satisfactory conformance even after the heating test, indicating that the optical filter of the present invention has heat resistance and that a satisfactory yield is maintained or improved even after the screening test involving heating.

A reflection spectrum obtained when light with a wavelength of 300 nm to 1200nm is allowed to be incident on the optical filter 1a at an incident angle of 5° at a temperature of 25° C. is not limited to a particular spectrum. For example, the optical filter 1a has, at a temperature of 25° C., a reflection spectrum satisfying the following requirements (I) and (II) when light with a wavelength of 300 nm to 1200 nm is allowed to be incident on the optical filter 1a at an incident angle of 5°. In this case, reflection of a portion of light belonging to the visible region and an infrared region is reduced in the optical filter 1a, and ghosting and flare are unlikely to occur, for example, in an imaging apparatus including the optical filter 1a. In addition, satisfying the requirement (1) is advantageous in reducing purple fringing, which is a kind of purple color bleeding appearing in a contour of a subject and is peculiar to this wavelength range.
(I) A maximum of a reflectance in a wavelength range of 300 nm to 400 nm is 8% or less
(II) An average reflectance in a wavelength range of 800 nm to 1150 nm is 10% or less

As for the requirement (I), the maximum of the reflectance in the wavelength range of 300 nm to 400 nm is desirably 6% or less in the above reflection spectrum.

As for the requirement (II), the average reflectance in the wavelength range of 800 nm to 1150 nm is desirably 8% or less, and more desirably 6% or less in the above reflection spectrum.

In some cases, when the optical filter is installed in a camera module or the like, light reflected by the optical filter is further reflected by a lens barrel, a housing, a lens, or the like included in the camera module to reach an image sensing device. When such internally reflected light reaches the image sensing device, ghosting or flare may occur in an image, degrading image quality of the obtained image. Therefore, it is desirable that the reflectance of the optical filter be low. In a reflection spectrum obtained when light with a wavelength of 300 nm to 1200 nm is allowed to be incident on the optical filter 1a at an incident angle of 5° at a temperature of 25° C., a maximum of the reflectance in the wavelength range of 450 nm to 600 nm is larger than, for example, a maximum of the reflectance in the wavelength range of 800 nm to 1150 nm. In this reflection spectrum, a difference obtained by subtracting the maximum of the reflectance in the wavelength range of 800 nm to 1150 nm from the maximum of the reflectance in the wavelength range of 450 nm to 600 nm is, for example, 5% or less, desirably 4% or less.

It is desirable that, in an image obtained by the imaging apparatus including the optical filter, ghosting and flare be reduced, purple fringing or the like be further reduced, and color unevenness exhibiting a difference in color tint between, for example, a central portion and a peripheral portion be reduced in a single image. On a light receiving surface of the image sensing device, a light beam incident on the central portion and a light beam incident on the peripheral portion cause a difference in incident angle of an incident light beam that is incident on the optical filter, including a principal light beam. The incident angle of the light beam incident on the central portion of the light receiving surface of the image sensing device to an optical filter is small, and the incident angle of the light beam incident on the peripheral portion to the optical filter is large. The difference in incident angle of the incident light beam in this manner can result in different transmission spectra of the optical filter, resulting in the difference in color tint. Thus, it is advantageous that the difference between the transmission spectra of the optical filter at different incident angles is small. Accordingly, the optical filter 1a desirably satisfies one or two or more of the following requirements (i′) to (vi'). Under the following requirements (i′) to (vi′), the representation |A-B| means an absolute value of a difference between a value of A and a value of B.

In a transmission spectrum obtained when light with a wavelength of 300 nm to 1200 nm is allowed to be incident on the optical filter 1a at incident angles of 40° and 60° at a temperature of 25° C., wavelengths which lie in the wavelength range of 350 nm to 450 nm and at which the transmittance is 50% are represented by 80 _{40/UV}^{25° C.} and λ_{60/UV}^{25° C.}, respectively. This transmission spectrum is obtained by measuring the optical filter 1a before the above heating test.
(i′) |λ_{40/UV}^{25° C.}-λ_{1-UV}^{25° C.}| has a value of 7 nm or less, and desirably 5 nm or less.
(ii′) |λ_{60/UV}^{25° C.}-λ_{1-UV}^{25° C.}| has a value of 14 nm or less, and desirably 10 nm or less.

In a transmission spectrum obtained when light with a wavelength of 300 nm to 1200 nm is allowed to be incident on the optical filter 1a at incident angles of 40° and 60° at a temperature of 25° C., wavelengths which lie in the wavelength range of 600 nm to 700 nm and at which the transmittance is 50% are represented by λ_{40/IR}^{25° C.} and λ_{60/IR}^{25° C.} respectively. This transmission spectrum is obtained by measuring the optical filter 1a before the above heating test.
(iii′) |λ_{40/IR}^{25° C.}-λ_{1-IR}^{25° C.}| has a value of 8 nm or less, and desirably 6 nm or less.
(iv′) |λ_{60/IR}^{25° C.}-λ_{1-IR}^{25° C.}| has a value of 16 nm or less, and desirably 12 nm or less.

In a transmission spectrum obtained when light with a wavelength of 300 nm to 1200 nm is allowed to be incident on the optical filter 1a at incident angles of 0°, 40°, and 60° at a temperature of 25° C., wavelengths which lie in the wavelength range of 600 nm to 700 nm and at which the transmittance is 20% are represented by λ_{0/20}^{25° C.}, λ_{40/20}^{25° C.} and λ_{60/20}^{25° C.}, respectively. This transmission spectrum is obtained by measuring the optical filter 1a before the above heating test. λ_{0/20}^{25° C.} may be equal to λ₁₋₂₀^{25° C.}
(v′) |λ_{40/20}^{25° C.}-λ_{0/20}^{25° C.}| has a value of 8 nm or less, and desirably 6 nm or less.
(vi′) |λ_{60/20}^{25° C.}-λ0/20^{25° C.}| has a value of 16 nm or less, and desirably 12 nm or less.

The optical filter 1a has a third transmission spectrum when light with a wavelength of 300 nm to 1200 nm is allowed to be incident on the optical filter at 70° C. at an incident angle of 0°. The third transmission spectrum is obtained by measuring the optical filter 1a before the above heating test. The third transmission spectrum is not limited to a particular spectrum. In the optical filter 1a, an absolute value |λ_{1-UV}^{25° C.}-λ_{UV}^{70° C.}| of a difference between the wavelength λ_{1-UV}^{25° C.} and the wavelength λ_{UV}^{70° C.} is not limited to a particular value. The wavelength λUV^{70° C.} is a wavelength which lies in the wavelength range of 350 nm to 450 nm and at which the transmittance is 50% in the third transmission spectrum. The absolute value |λ_{1-UV}^{25° C.}-λ_{UV}^{70° C.}| is, for example, 10 nm or less. In this case, even when the optical filter 1a is placed in an environment at room temperature and a relatively high temperature, a wavelength which lies in the wavelength range of 350 nm to 450 nm and at which the transmittance is 50% is unlikely to vary, reducing a shift or an offset in the transmission spectrum. Because of this, the optical filter 1a is likely to have a transmission spectrum with a small temperature dependency, and is likely to have desired heat resistance.

The absolute value |λ_{1-UV}^{25° C.}-λ_{UV}^{70° C.}| is desirably 9 nm or less, and more desirably 8 nm or less.

In the optical filter 1a, an absolute value |λ_{1-IR}^{25° C.}-λ_{IR}^{70° C.}| of a difference between the wavelength λ_{1-IR}^{25° C.} and the wavelength λ_{IR}^{70° C.} is not limited to a particular value. The wavelength λ_{IR}^{70° C.} is a wavelength which lies in the wavelength range of 600 nm to 700 nm and at which the transmittance is 50% in the third transmission spectrum. The absolute value |λ_{1-IR}^{25° C.}-λ_{IR}^{70° C.}| is, for example, 10 nm or less. In this case, even when the optical filter 1a is placed in an environment at room temperature and a relatively high temperature, a wavelength which lies in the wavelength range of 600 nm to 700 nm and at which the transmittance is 50% is unlikely to vary, reducing a shift or an offset in the transmission spectrum. Because of this, the optical filter 1a is likely to have a transmission spectrum with a small temperature dependency, and is likely to have desired heat resistance.

In the optical filter 1a, an absolute value |T₄₀₀^{25° C.}-T₄₀₀^{70° C.}| of a difference between a transmittance T₄₀₀^{25° C.} and a transmittance T₄₀₀^{70° C.} is not limited to a particular value. The transmittance T₄₀₀^{25° C.} is a transmittance at a wavelength of 400 nm in the first transmission spectrum. The transmittance T₄₀₀^{70° C.} is a transmittance at a wavelength of 400 nm in the third transmission spectrum. The absolute value |T₄₀₀^{25° C.}-T₄₀₀^{70° C.}| is, for example, 20% or less. In this case, even when the optical filter 1a is placed in an environment at room temperature and a relatively high temperature, the transmittance at a wavelength of 400 nm is unlikely to vary, reducing a shift or an offset in the transmission spectrum. Because of this, the optical filter 1a is likely to have a transmission spectrum with a small temperature dependency, and is likely to have desired heat resistance. Furthermore, when 400 nm<λ_{1-UV}^{25° C.} and/or 400 nm<λ_{UV}^{70° C.}, the wavelength of 400 nm belongs to a band in which the transmittance abruptly increases from zero or near zero in the spectrum of the optical filter 1a, and thus the temperature dependency of the transmission spectrum of the optical filter 1a can be further reduced.

The absolute value |T₄₀₀^{25° C.}-T₄₀₀^{70° C.}| is desirably 19% or less, more desirably 18% or less, and even more desirably 17% or less.

As shown in FIG. 1A, the optical filter 1a is in the form of, for example, a film, and includes a resin as a main component. The term “main component” as used herein refers to a component that is most abundantly included on a mass basis. The thickness of the optical filter 1a is not limited to a particular value. The thickness is, for example, 65 μm to 600 μm, and desirably 90 μm to 300 μm. The optical filter 1a being thinner can contribute to the lower profile of the imaging apparatus. Meanwhile, the optical filter 1a having a thickness equal to or larger than a given value can prevent warpage or wrinkling of the optical filter 1a in manufacturing of the imaging apparatus and degradation in image quality.

A haze (or haze value or degree of cloudiness) of the optical filter 1a is not limited to a particular value. The optical filter 1a has a haze of, for example, 0.5% or less. The optical filter having a smaller haze has a higher transparency, and is suitable for improving the image quality of an image that can be acquired by the imaging apparatus. For example, even in a case where the optical filter has a spectrum with a high transmittance in the visible region, when the haze of the optical filter is large, light scattering occurs inside the optical filter or on the surface of the optical filter, increasing the tendency of cloudiness or opacity. Therefore, it is important to evaluate the optical filter based on the haze. The optical filter 1a desirably has a haze of 0.3% or less.

The optical filter 1a can be manufactured, for example, by curing a given light-absorbing composition. The light-absorbing composition includes a light-absorbing compound, a curable resin, at least one selected from the group consisting of an alkoxysilane and a hydrolysate of an alkoxysilane, and water. The light-absorbing compound absorbs a portion of light belonging to a wavelength range of 300 nm to 380nm and a portion of light belonging to a wavelength range of 700 nm to 1200 nm. It is expected that, in the process of heating and curing such a light-absorbing composition, a reaction will occur so that excess water will not evaporate and a silane compound will not volatilize as the temperature is increased relatively gradually from room temperature (15° C. to 35° C.). Formation of an —O—Si—O— bond is promoted through a silanol group of the hydrolyzed alkoxysilane, and a strong crosslinked structure can be formed in the optical filter 1a. The optical filter 1a is likely to have desired heat resistance by including an appropriate amount of such a strong crosslinked structure.

An amount of water in the light-absorbing composition is not limited to a particular value. The amount of water in the light-absorbing composition is, for example, 700 parts per million (ppm) to 7000 ppm on a mass basis. In this case, in curing of the light-absorbing composition, water necessary for hydrolysis of the alkoxysilane is supplied, and a function of promoting polycondensation of the hydrolyzed alkoxysilane through the silanol group is expected.

The amount of water in the light-absorbing composition is desirably 1200 ppm or more, and more desirably 3500 ppm or more. Moreover, the amount of water in the light-absorbing composition is desirably 6600 ppm or less, may be 5000 ppm or less, may be 4000 ppm or less, and may be less than 1000 ppm. The amount of water in the light-absorbing composition can be adjusted according to the heat resistance required of the optical filter 1a. The amount of water in the light-absorbing composition can be adjusted by addition of water in preparation of the light-absorbing composition. In the case where a hydrate is used for the preparation of the light-absorbing composition, the amount of water may be adjusted by taking into account a sum of the added amount of water and the amount derived from the hydrate.

When the amount of water in the light-absorbing composition is 7000 ppm or less, a possibility that a reaction involving water in curing of the light-absorbing composition will locally proceed abruptly is reduced, and occurrence of aggregation or phase separation of the light-absorbing compound is likely to be reduced. As a result, formation of a scatterer inside or on the surface of the optical filter 1a, occurrence of a fissure or a crack, and an increase in haze are likely to be reduced.

A method for manufacturing the optical filter 1a by curing the light-absorbing composition is not limited to a particular method. For example, the light-absorbing composition has the curable resin cured by a step including the following heating steps (a), (b), (c), and (d). This makes it possible to manufacture the optical filter 1a. Room temperature is, for example, 15° C. to 35° C. According to such a method, a balance between evaporation of components such as the water and the silane compound and promotion of the reaction in curing of the light-absorbing composition, which are attributable to heating, is likely to be set in a desired state. For example, excessive evaporation of water is reduced, and a reaction for curing and removal by evaporation of a by-product is adjusted to a desired state, making it possible to prevent wrinkling of the optical filter due to the reaction for curing being too fast, and an increase in haze.
(a) Heating at a first heating temperature included in a temperature range of room temperature to 60° C. for 2 hours or more
(b) Heating at a second heating temperature included in a temperature range of the first heating temperature to 100° C. for 2 hours or more
(c) Heating at a third heating temperature included in a temperature range of the second heating temperature to 140° C. for 2 hours or more
(d) Heating at a fourth heating temperature included in a temperature range of the third heating temperature to 200° C. for 1 hour or more

In the manufacturing of the optical filter 1a, exposure to an atmosphere having a relatively high humidity for a certain period of time, which is what is called a humidification treatment, may be performed. By the humidification treatment, moisture in the atmosphere can promote hydrolysis of the alkoxysilane included in the light-absorbing composition, facilitating formation of an —O—Si—O— bond. Moreover, by the humidification treatment, the optical filter 1a in which fine particles including a light absorbent are not aggregated and which is hard and dense can be manufactured.

The light-absorbing compound is not limited to a particular substance as long as the light-absorbing compound absorbs a portion of light belonging to the wavelength range of 300 nm to 380 nm and a portion of light belonging to the wavelength range of 700 nm to 1200 nm. The light-absorbing compound includes, for example, a phosphonic acid and a copper component.

The phosphonic acid in the light-absorbing compound is not limited to a particular phosphonic acid. The phosphonic acid is, for example, represented by the following formula (a). In the formula (a), R₁ is an alkyl group or a halogenated alkyl group in which at least one hydrogen atom in an alkyl group is substituted by a halogen atom. In this case, a transmission band of the optical filter 1a is likely to extend to a wavelength around 700 nm, and the optical filter 1a is likely to have desired transmittance properties.

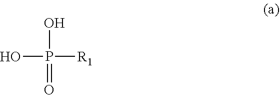

The phosphonic acid is, for example, methylphosphonic acid, ethylphosphonic acid, normal(n-)propylphosphonic acid, isopropylphosphonic acid, normal(n-)butylphosphonic acid, isobutylphosphonic acid, sec-butylphosphonic acid, tert-butylphosphonic acid, or bromomethylphosphonic acid.

As for the phosphonic acid in the light-absorbing compound, in the formula (a), R₁ may include an aryl group or a halogenated aryl group in which at least one hydrogen atom in an aryl group is substituted by a halogen atom. The aryl group is, for example, a phenyl group. The halogenated aryl group is, for example, a halogenated phenyl group. This makes it easier for the optical filter 1a to have desired transmittance properties.

The copper component in the light-absorbing compound is a concept including a copper ion, a copper complex, a copper-including compound, and the like. The copper component can have desirable absorption properties with respect to a portion of light belonging to near-infrared region and high light transmitting properties with respect to light in a visible region extending from 450 nm to 680 nm. Specifically, by electronic transition in the d-orbital of a divalent copper ion, the copper component selectively absorbs light having a wavelength corresponding to this energy to exhibit excellent near-infrared absorption properties, the wavelength belonging to a near-infrared region. In particular, a divalent copper ion may be mixed, in a copper salt state, with the phosphonic acid to form a copper complex (copper salt) with the phosphonic acid coordinating to the copper ion.

A source of the copper component in the light-absorbing compound is not limited to a particular substance. The source of the copper component is, for example, a copper salt. The copper salt may be an anhydride or a hydrate of copper chloride, copper formate, copper stearate, copper benzoate, copper pyrophosphate, copper naphthenate, or copper citrate. For example, copper acetate monohydrate is represented by Cu(CH₃COO)₂·H₂O, and 1 mol of copper acetate monohydrate provides 1mol of copper ion. One of these copper salts may be used alone, or two or more of these copper salts or a mixture thereof may be used.

The amounts of the copper component and the phosphonic acid in the light-absorbing compound are not limited to particular values. A ratio of the amount of the phosphonic acid to the amount of the copper component in the light-absorbing compound is, for example, 0.3 to 1.5 on an amount-of-substance (mole) basis. The ratio of the amount of the phosphonic acid to the amount of the copper component in the light-absorbing compound may be desirably 0.4 to 1.4, more desirably 0.6 to 1.2, or even more preferably 0.8 to 1.1.

The light-absorbing compound may be a compound including a sulfonic acid and a copper component, or may be a phosphoric acid-copper complex represented by MₙCu_{y}PO_{4-z} (where M is a metal element other than Cu). The light-absorbing compound may be an inorganic compound such as a tungsten complex represented by MₓWO_{4-y} (where M is a metal element other than W), or may be an organic compound such as a phthalocyanine compound, a cyanine compound, a squarylium compound, or an azo compound.

The curable resin is not limited to a particular resin. The curable resin is, for example, a resin capable of holding the light-absorbing compound in a dispersed or dissolved state. It is desirable that the curable resin be liquid in an uncured or unreacted state and that the curable resin be capable of allowing the light-absorbing compound to be dispersed or dissolved therein. Furthermore, the curable resin can desirably form a coating film by being applied to any object by a coating technique such as spin coating, spraying, dipping, or dispensing. The object on which the coating film is formed is a substrate having any surface, whether plane or curved. The curable resin can be desirably cured by heating, humidification, irradiation with energy such as light, or a combination of these. In the curable resin, a transmission spectrum of a plate-shaped 1 mm-thick body having a flat and smooth surface and formed by curing the curable resin may satisfy at least one of the following requirements: the transmittance in the wavelength range of 450 nm to 800 nm is 90% or more. Examples of the curable resin include cyclic polyolefin resins, epoxy resins, polyimide resins, modified acrylic resins, silicone resins, and polyvinyl resins such as PVB.

The inclusion of at least one selected from the group consisting of an alkoxysilane and a hydrolysate of an alkoxysilane in the light-absorbing composition can prevent particles of the light-absorbing compound from aggregating with each other. Because of this, the light-absorbing compound is dispersed well in the light-absorbing composition, and the light absorbent is likely to be dispersed well in the optical filter 1a. Therefore, in curing of the light-absorbing composition, an —O—Si—O— bond is formed by a treatment for sufficient hydrolysis and polycondensation reactions of the alkoxysilane, and thus the optical filter 1a is likely to have high moisture resistance. In addition, the optical filter 1a is likely to have high heat resistance. This is because a siloxane bond is greater in binding energy and chemically more stable than bonds such as a —C—C— bond and a —C—O— bond and is thus excellent in heat resistance and moisture resistance.

The alkoxysilane is not limited to a particular alkoxysilane as long as the optical filter 1a includes a hydrolysis-polycondensation compound formed by hydrolysis and polycondensation reactions and having a siloxane bond. The alkoxysilane may be, for example, such a monomer as tetramethoxysilane, tetraethoxysilane, methyltrimethoxysilane, methyltriethoxysilane, dimethyldiethoxysilane, dimethyldimethoxysilane, phenyltrimethoxysilane, phenyltriethoxysilane, 3-glycidoxypropyltrimethoxysilane, 3-glycidoxypropyltriethoxysilane, or 3-glycidoxypropylmethyldiethoxysilane, or may be a dimer, an oligomer, or the like formed by bonding a monomer selected from some of the above monomers.

The light-absorbing composition may further include, for example, a phosphoric acid ester compound. The phosphoric acid ester compound facilitates satisfactory dispersion of the light-absorbing compound in the light-absorbing composition. The phosphoric acid ester may function as a dispersant for the light-absorbing compound. A portion of the phosphoric acid ester may react with a metal component to form a compound. For example, the phosphoric acid ester may coordinate to the light-absorbing compound, may react with the light-absorbing compound, or may partly form a complex with the copper component. As long as the optical filter 1a satisfies the requirements relating to the given transmission spectra, the compound including the phosphoric acid ester and the copper component also may absorb light having a wavelength in a given range. The light-absorbing composition may be substantially free of the phosphoric acid ester as long as the light-absorbing substance including at least the phosphonic acid and the copper component can be suitably dispersed in the light-absorbing composition being a precursor of the optical filter 1a. Furthermore, for example, when the light-absorbing composition includes at least one selected from the group consisting of an alkoxysilane and a hydrolysate of an alkoxysilane to impart a dispersing function, the amount of the phosphoric acid ester added can be decreased.

The phosphoric acid ester is not limited to a particular phosphoric acid ester or a compound of a particular phosphoric acid ester. The phosphoric acid ester has, for example, a polyoxyalkyl group. Examples of such a phosphoric acid ester include PLYSURF A208N (polyoxyethylene alkyl (C12, C13) ether phosphoric acid ester), PLYSURF A208F (polyoxyethylene alkyl (C8) ether phosphoric acid ester), PLYSURF A208B (polyoxyethylene lauryl ether phosphoric acid ester), PLYSURF A219B (polyoxyethylene lauryl ether phosphoric acid ester), PLYSURF AL (polyoxyethylene styrenated phenyl ether phosphoric acid ester), PLYSURF A212C (polyoxyethylene tridecyl ether phosphoric acid ester), and PLYSURF A215C (polyoxyethylene tridecyl ether phosphoric acid ester). All of these are products manufactured by DKS Co., Ltd. Examples of the phosphoric acid ester include NIKKOL DDP-2 (polyoxyethylene alkyl ether phosphoric acid ester), NIKKOL DDP-4 (polyoxyethylene alkyl ether phosphoric acid ester), and NIKKOL DDP-6 (polyoxyethylene alkyl ether phosphoric acid ester). All of these are products manufactured by Nikko Chemicals Co., Ltd. One of these phosphoric acid ester compounds may be used alone, or two or more of these may be used in combination.

The amounts of the phosphonic acid and the phosphoric acid ester in the light-absorbing composition or the optical filter 1a are not limited to particular values. A ratio of the amount of the phosphonic acid to the amount of the phosphoric acid ester in the light-absorbing composition or the optical filter 1a is, for example, 0.6 to 1.6 on a mass basis. In this case, hydrolysis of the phosphoric acid ester is reduced and the optical filter 1a is likely to have high weather resistance, the hydrolysis being caused by bringing the optical filter 1a into contact with water vapor. The ratio of the amount of the phosphonic acid to the amount of the phosphoric acid ester in the light-absorbing composition or the optical filter 1a may be desirably 0.7 to 1.5, and more desirably 0.8 to 1.4.

A ratio of the amount of the copper component to the amount of a phosphorus component in the light-absorbing composition or the optical filter 1a is not limited to a particular value. The ratio of the amount of the copper component to the amount of the phosphorus component in the light-absorbing composition or the optical filter 1a is, on a mass basis, for example, 1.0 to 3.0, and desirably 1.5 to 2.0. The phosphorus component may be derived from the phosphonic acid included in the light-absorbing composition, may be derived from the phosphonic acid and the phosphoric acid ester included in the light-absorbing composition, or may be included in an additive.

The light-absorbing composition may include a curing catalyst to be involved in curing of a curable resin. The curing catalyst may be a catalyst that can control conditions such as the curing speed of the curable resin, the reactivity of the curable resin in curing, and the hardness of a cured product of the curable resin.

The curing catalyst is desirably an organic compound (organic metal compound) including a metal component. The organic metal compound is not limited to a particular compound. An organic aluminum compound, an organic titanium compound, an organic zirconium compound, an organic zinc compound, an organic tin compound, or the like may be used as the organic metal compound.

The organic aluminum compound is, for example, but not limited to, an aluminum salt compound such as aluminum triacetate or hydroxyaluminium bis(2-ethylhexanoate), an aluminum alkoxide compound such as aluminum trimethoxide, aluminum triethoxide, aluminum dimethoxide, aluminum diethoxide, aluminum triallyl oxide, aluminum diallyl oxide, or aluminum isopropoxide, or an aluminum chelate compound such as aluminum methoxy bis(ethylacetoacetate), aluminum methoxy bis(acetylacetonate), aluminum ethoxy bis(ethylacetoacetate), aluminum ethoxy bis(acetylacetonate), aluminum isopropoxy bis(ethylacetoacetate), aluminum isopropoxy bis(methylacetoacetate), aluminum isopropoxy bis(t-butylacetoacetate), aluminum butoxy bis(ethylacetoacetate), aluminum dimethoxy (ethylacetoacetate), aluminum dimethoxy (acetylacetonate), aluminum diethoxy (ethylacetoacetate), aluminum diethoxy (acetylacetonate), aluminum diisopropoxy (ethylacetoacetate), aluminum diisopropoxy (methylacetoacetate), aluminum tris(ethylacetoacetate), or aluminum tris(acetylacetonate). One of these may be used alone, or two or more of these may be used in combination.

The organic titanium compound is, for example, but not limited to, a titanium chelate such as titanium tetraacetylacetonate, dibutyloxy titanium diacetylacetonate, titanium ethylacetoacetate, titanium octylene glycolate, or titanium lactate, or a titanium alkoxide such as tetraisopropyl titanate, tetrabutyl titanate, tetramethyl titanate, tetra(2-ethylhexyl titanate), titanium tetra-2-ethylhexoxide, titanium butoxy dimer, titanium tetra-normal-butoxide, titanium tetraisopropoxide, or titanium diisopropoxy bis(ethylacetoacetate). One of these may be used alone, or two or more of these may be used in combination.

The organic zirconium compound is, for example, but not limited to, a zirconium chelate such as zirconium tetraacetylacetonate, zirconium dibutoxy bis (ethylacetoacetate), zirconium monobutoxy acetylacetonate bis (ethylacetoacetate), or zirconium tributoxy monoacetylacetonate, or a zirconium alkoxide such as zirconium tetra-normal-butoxide or zirconium tetra-normal-propoxide. One of these may be used alone, or two or more of these may be used in combination.

Examples of the organic zinc compound include zinc alkoxides such as dimethoxyzinc, diethoxyzinc, and ethylmethoxyzinc. One of these may be used alone, or two or more of these may be used in combination.

Examples of the organic tin compounds include tin alkoxides such as dimethyltin oxide, diethyltin oxide, dipropyltin oxide, dibutyltin oxide, dipentyltin oxide, dihexyltin oxide, diheptyltin oxide, and dioctyltin oxide. One of these may be used alone, or two or more of these may be used in combination.

The light-absorbing composition may further include, as the curing catalyst, at least one selected from the group consisting of an alkoxide including a metal component and a hydrolysate of an alkoxide including a metal component, as described above. The alkoxide including the metal component and the hydrolysate of the alkoxide including the metal component are each referred to as “metal alkoxide compound”. The metal alkoxide compound is represented by a general formula M(OR)ₙ (where M is a metal element, and n is an integer of one or greater), and is a compound in which a hydrogen atom in a hydroxy group of an alcohol has been substituted with the metal element M. One molecule of the metal alkoxide compound forms M—OH by hydrolysis, and further forms an M—O—M bond by a reaction with another molecule of the metal alkoxide compound. For example, when the light-absorbing composition having fluidity is cured into the optical filter 1a, the metal alkoxide compound may be one that can function as a catalyst for promoting curing of the light-absorbing composition. In the case of curing the light-absorbing composition by a heating treatment, the higher the heat treatment temperature is, the more likely a tolerance to environmental conditions, such as thermal resistance, is to be enhanced. However, a high heat treatment temperature may decrease properties of the light-absorbing compound. However, in the case of the optical filter 1a including the metal alkoxide compound, it is possible to promote curing of the light-absorbing composition even at a low heating treatment temperature. As a result, the optical filter 1a is likely to have a high tolerance to environmental conditions.

The metal component included in the metal alkoxide compound is not limited to a particular component. Examples of the metal component include Al, Ti, Zr, Zn, Sn, and Fe. Examples of the metal alkoxide can include CAT-AC and DX-9740 each being an aluminum alkoxide manufactured by Shin-Etsu Chemical Co., Ltd., ORGATIX AL-3001 being an aluminum alkoxide manufactured by Matsumoto Fine Chemical Co., Ltd., aluminum isopropoxide being an aluminum alkoxide manufactured by Tokyo Chemical Industry Co., Ltd., D-20, D-25, and DX-175 each being a titanium alkoxide manufactured by Shin-Etsu Chemical Co., Ltd., ORGATIX TA-8, TA-21, TA-30, TA-80, and TA-90 each being a titanium alkoxide manufactured by Matsumoto Fine Chemical Co., Ltd., D-15 and D-31 each being a zirconium alkoxide manufactured by Shin-Etsu Chemical Co., Ltd., and ORGATIX ZA-45 and ZA-65 each being a zirconium alkoxide manufactured by Matsumoto Fine Chemical Co., Ltd.

A ratio of the amount of the copper component to the amount of the metal component included in the metal alkoxide compound in the optical filter 1a is not limited to a particular value. The ratio of the amount of the copper component to the amount of the metal component included in the metal alkoxide compound in the optical filter 1a may be, on a mass basis, 1×10² to 7×10², desirably 2×10² to 6×10², and even more desirably 3×10² to 5×10².

Furthermore, a ratio of the amount of the phosphorus component to the amount of the metal component included in the metal alkoxide compound in the optical filter 1a is not limited to a particular value. The ratio of the amount of the phosphorus component to the amount of the metal component included in the metal alkoxide compound in the optical filter 1a may be, on a mass basis, 0.5×10² to 5×10², desirably 1×10² to 4×10², and even more desirably 1.5×10² to 3×10².

The light-absorbing composition may include an ultraviolet absorbent that absorbs a portion of light belonging to ultraviolet light. The ultraviolet absorbent is not limited to a particular compound as long as the first transmission spectrum of the optical filter 1a satisfies a given requirement.

The ultraviolet absorbent is selected desirably in view of absorbing light in a desired wavelength range, having compatibility with a particular solvent, dispersing well in the light-absorbing composition, particularly, for example, the curable resin, having an excellent tolerance to environmental conditions, and the like. Examples of the ultraviolet absorbent include a benzophenone-based compound, a benzotriazole-based compound, a salicylic-acid-based compound, and a triazine-based compound. For example, Tinuvin

PS, Tinuvin 99-2, Tinuvin 234, Tinuvin 326, Tinuvin 329, Tinuvin 900, Tinuvin 928, Tinuvin 405, and Tinuvin 460 can be used as the ultraviolet absorbent. These are ultraviolet absorbents manufactured by BASF, and Tinuvin is a registered trademark.

The amount of the ultraviolet absorbent in the optical filter 1a is not limited to a particular value as long as the first transmission spectrum of the optical filter 1a satisfies a given requirement. A high absorbing ability can be exhibited even with a small amount of the ultraviolet absorbent. A ratio of the amount of the ultraviolet absorbent to the amount of the copper component in the optical filter 1a is, for example, 0.01 to 1, desirably 0.02 to 0.5, and more desirably 0.07 to 0.14 on a mass basis. A ratio of the amount of the ultraviolet absorbent to the phosphorus component in the light absorber 10 is, for example, 0.02 to 2, desirably 0.04 to 1, more desirably 0.12 to 0.26 on a mass basis.

For example, as shown in FIG. 1B, FIG. 1C, and FIG. 1D, articles 10a, 10b, and 10c with an optical filter 1a can be provided.

As shown in FIG. 1B, the optical filter 1a may be arranged on a support 20. The support 20 is not limited to a particular support. The support 20 is, for example, a transparent dielectric such as glass or a resin. When the support 20 is, for example, rigid, the rigidity of an article including the optical filter 1a increases, the optical filter 1a is easy to handle in assembly of a product such as an imaging apparatus, and the degradation in image quality can be reduced. The support 20 may have a plate shape, or may be one or a plurality of lenses included in a lens system of an imaging apparatus. The support 20 may have a planar principal surface, or may have a curved principal surface. The support 20 may be an optical element (including an acousto-optic element) such as a mirror, a prism, a diffuser, a planar microlens array, a polarizer, a diffraction grating, a hologram, an optical modulation device, an optical deflection device, or a filter. The support 20 may be a solid-state image sensing device, or a light-transmitting shield such as a window of a building, an automotive window, a windshield, a helmet, or goggles. The support 20 may be a display apparatus such as a display or a screen.

As shown in FIG. 1C, when the optical filter 1a has a plate shape, a given functional film 31 or functional layer 32 may be formed on at least one principal surface of the optical filter 1a. The functional film 31 or the functional layer 32 is not limited to a particular film or layer. The functional film 31 or the functional layer 32 may be: a hard coating film (hard coat) or hard coating layer; a reflection reduction film or reflection reduction layer or an antireflection film or antireflection layer; a reflecting film or a reflective layer; a polarizing film or polarizing layer; or a wavelength-selective light-absorbing film or wavelength-selective light-absorbing layer. The hard coating film or the hard coating layer is a film or layer for enhancement in scratch resistance. The reflection reduction film or reflection reduction layer or the antireflection film or antireflection layer is a film or layer for reducing reflected light belonging to a particular wavelength range from a surface thereof or preventing occurrence of the reflected light when light is allowed to be incident on the optical filter 1a. Hereinafter, the reflection reduction film and the antireflection film are collectively referred to as “antireflection film”. The reflecting film or reflective layer is a film or layer for reflecting light belonging to a particular wavelength range from a surface thereof to a larger extent when light is allowed to be incident on the optical filter 1a. The polarizing film or polarizing layer is a film or layer for reducing the transmittance of light having a polarization direction different from a particular direction when light is allowed to be incident on the optical filter 1a. The wavelength-selective light-absorbing film or wavelength-selective light-absorbing layer is a film or layer for absorbing light in a partial wavelength range. The functional film 31 or functional layer 32 may be composed of a single film or layer being one of these functional films and functional layers, or may be composed of two or more of these functional films or functional layers.

When the functional film 31 is an antireflection film, the antireflection film may be arranged on one principal surface or both principal surfaces of the optical filter 1a. The principal surface of the optical filter 1a is a surface of the optical filter 1a having the largest area.

The antireflection film is formed, for example, of one or more materials. The material of the antireflection film is not limited to a particular material. The antireflection film is, for example, a film including SiO₂, SiO_{1.5}, TiO₂, or TiO_{1.5} as a main component. The antireflection film is formed, for example, by a method such as a sol-gel process. In the antireflection film, fine hollow particles or fine particles of a low refractive index material may be dispersed in the main component of the antireflection film. The antireflection film may be a film including TiO₂, Ta₂O₃, SiO₂, Nb₂O₅, ZnS, MgF, or a mixture thereof. This film may be formed by a method such as deposition, sputtering, or ion plating. The deposition may be ion-beam-assisted deposition. The antireflection film may be a single-layer film including any of the above materials or a multilayer film (dielectric multilayer film) in which films of different materials are alternately stacked. Moreover, the antireflection film may be formed in contact with the optical filter 1a, or may be formed in contact with another functional film or functional layer formed in contact with the optical filter 1a.

The antireflection film may be a film including silicon and formed by the sol-gel process. According to the sol-gel process, an antireflection film can be formed at a low temperature, and a film including a crosslinkable structure ascribable to an —O—Si—O— bond can be formed in the same manner as in the case of glass. Because of this, the antireflection film is likely to be high in reliability, and a silica component having a relatively low refractive index can be used as a main component of the film. Thus, the sol-gel process is suitable as a method for forming the antireflection film.

Materials used in the sol-gel process may include a trifunctional silane including a hydrocarbon group such as methyltriethoxysilane (MTES) and a tetrafunctional silane such as tetraethoxysilane (TEOS). A ratio A1/A2 of an amount A1 of the trifunctional silane to an amount A2 of the tetrafunctional silane in the materials used in the sol-gel process is, for example, 0.5 to 5 on a mass basis. The occurrence of a crack in the film can be reduced by virtue of the trifunctional silane, and a strong skeleton is expected to be formed by virtue of the tetrafunctional silane.

In addition, for example, when the optical filter 1a is formed of the light-absorbing composition including at least one selected from the group consisting of an alkoxysilane and a hydrolysate of an alkoxysilane, it is expected that defects such as delamination at an interface between the optical filter 1a and the antireflection film will be reduced. In the sol-gel process, for example, a coating film is baked in a range of 60° C. to 170° C. The baking of the coating film may be desirably performed in a range of 60° C. to 150° C., or may be performed in a range of 60° C. to 115° C. Since the optical filter 1a has the desired heat resistance, a strong antireflection film can be formed without defects such as decomposition product generation even when the coating film is baked at a high temperature. The baking time of the coating film is, for example, 1 minute to 10 hours, and desirably 0.5 hours to 6 hours. The baking may be performed under a condition that the heating temperature is changed stepwise every given time, such as at 40° C. for 1 hour, at 60° C. for 1 hour, and at 85° C. for 1 hour.

When the functional film 31 is a light-reflecting film, a given light-blocking ability may be exhibited by cooperation between the optical filter 1a and the functional film 31. Transmission of light belonging to a particular wavelength range can be reduced or such light can be blocked by such cooperation, and thus light absorption properties required of the optical filter 1a are likely to be reduced. Therefore, for example, the thickness of the optical filter 1a is likely to be reduced. Moreover, for example, the amount of the light-absorbing compound such as the light absorbent in the optical filter 1a is likely to be reduced.

The wavelength-selective light-absorbing film is not limited to a particular film. The wavelength-selective light-absorbing film may be a film made of a metal such as Ag (silver), Al (aluminum), Au (gold), or Pt (platinum) or may be a film including a compound including one or more of these metals or one or more of metals other than these metals. In particular, a metal film is likely to be compatible with a wide wavelength range and to have a simple structure. Therefore, a metal film can be used as a readily available film capable of exhibiting a light reflection function or a light absorption function. Such a wavelength-selective light-absorbing film can be used as a neutral density (ND) filter or a half mirror.

As shown in FIG. 1D, a given functional film 31 or functional layer 32 may be formed on at least one principal surface of a stacked body including the support 20 and the optical filter 1a.

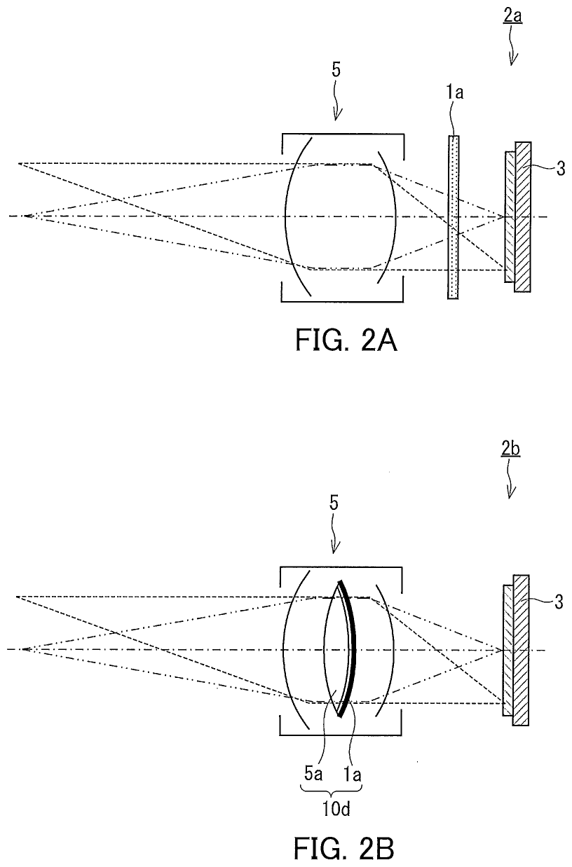

For example, an imaging apparatus including the optical filter 1a can be provided. The imaging apparatus is sometimes referred to as “camera” or “camera module”. FIG. 2A is a cross-sectional view schematically showing an example of an imaging apparatus according to the present invention. An imaging apparatus 2a includes the optical filter 1a.

The imaging apparatus 2a further includes a solid-state image sensing device 3 and a lens group 5. The solid-state image sensing device 3 includes, for example, a CMOS or a CCD. The lens group 5 collects light from a subject to the solid-state image sensing device 3. The imaging apparatus 2a may further include a casing including a shield or a housing, a lens driving apparatus, a circuit board for driving the solid-state image sensing device 3, or a driver. Illustration of these parts or members is omitted in FIG. 2A. In the imaging apparatus 2a, light from a subject passes through the lens group 5 and the optical filter 1a, and light belonging to a particular wavelength region reaches the solid-state image sensing device 3.

FIG. 2B is a cross-sectional view schematically showing another example of the imaging apparatus according to the present invention. An imaging apparatus 2b is configured in the same manner as in the imaging apparatus 2a except for a portion to be particularly described. In the imaging apparatus 2b, the optical filter 1a is arranged on a surface of one or two or more lenses 5a included in the lens group 5. The imaging apparatus 2b includes a lens 10d with an optical filter, which includes the optical filter 1a and the lens 5a. The imaging apparatus 2b may further include a casing including a shield or a housing, a lens driving apparatus, a circuit board for driving the solid-state image sensing device 3, or a driver. Illustration of these parts and members is omitted in FIG. 2B. In the imaging apparatus 2b, light from a subject passes through the lens group 5 including the lens 10d with an optical filter, and light belonging to a particular wavelength region reaches the solid-state image sensing device 3. The arrangement of the lens 10d with an optical filter in the lens group 5 is not limited to a particular arrangement.

The imaging apparatus (camera) can be installed in smartphones, in addition to being provided as a digital camera. In addition, the imaging apparatus can be installed in a manned or unmanned moving body such as an automobile, a vessel, an aircraft, or a drone. In particular, in the field of manned vehicles (hereinafter referred to simply as “automobiles”), the imaging apparatus can be used for preventive safety, monitoring of surrounding areas, or monitoring of the inside of a vehicle.

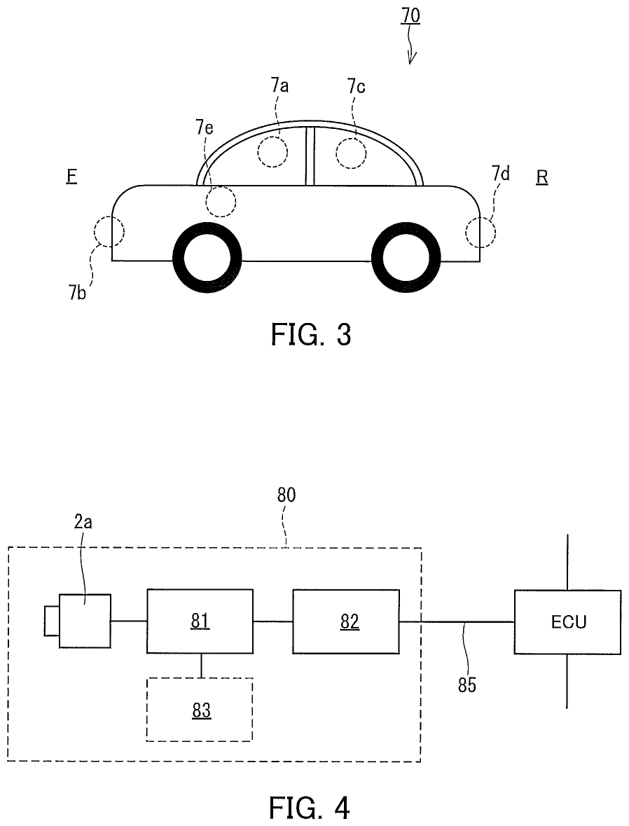

FIG. 3 is a diagram schematically showing an automobile including the imaging apparatus according to the present invention. Illustration of FIG. 3 is exemplary, and applications of the imaging apparatus, functions involving the imaging apparatus, locations of the imaging apparatus, and the like are not limited to an embodiment described below. The imaging apparatus disposed inside or outside the vehicle is referred to herein as “vehicle-mounted camera”. The vehicle-mounted camera is installed not only in automobiles but also in all moving bodies including, as described above, vessels, aircrafts and unmanned aerial vehicles such drones, and may be manned or unmanned. The imaging apparatus installed in an automobile may also be used, for example, for application to a dashboard camera, a driving assistance function for ensuring preventive safety, or monitoring of an outer periphery of the vehicle or the inside of the vehicle.

As shown in FIG. 3, in an automobile 70, an imaging apparatus 7a is a front camera inside the vehicle, and an imaging apparatus 7b is a front camera outside the vehicle. An imaging apparatus 7c is a rear camera inside the vehicle, and an imaging apparatus 7d is a rear camera outside the vehicle. An imaging apparatus 7e is a side camera. In FIG. 3, “F” indicates the front side of the automobile 70, and “R” indicates the rear side of the automobile. Each of the imaging apparatus 7a, the imaging apparatus 7b, the imaging apparatus 7c, the imaging apparatus 7d, and the imaging apparatus 7e includes the optical filter 1a.

It is important that an imaging apparatus that is intended to be installed in an automobile be resistant to changes in environmental temperatures. Automobiles can be used in extremely cold environments around poles, in burning environments right at the equator, or in environments with very large temperature differences between daytime and nighttime. It is thought that when an optical filter used in an imaging apparatus particularly includes an organic dye as a light absorbent, the light absorbent may deteriorate in a high-temperature environment to significantly decrease in its ability to absorb light. Meanwhile, even when the optical filter 1a is placed in, for example, an environment of 70° C. or an environment of 125° C., the performance of the optical filter 1a does not greatly decrease and can maintain almost initial performance. Thus, the optical filter 1a is suitable for an imaging apparatus that is intended to be installed in an automobile.

An image taken by the vehicle-mounted camera can be used, for example, in an apparatus for a vehicle driving assistance function. The image taken by the vehicle-mounted camera may be displayed on a given display so that the image can be recognized by a human inside the vehicle or outside the vehicle. Meanwhile, the image taken by the vehicle-mounted camera may be input to a given computer, and the computer may recognize the image. This can provide an image sensing technique (hereinafter referred to simply as “image sensing”) in which a particular function is exhibited on the basis of an analysis result of the image on the computer. The image sensing can be used to achieve, for example, automatic braking or emergency collision reducing braking of an automobile. The image sensing is also expected to be applied to automatic driving.

The imaging apparatuses 7a and 7b can be involved in, for example, functions such as collision prevention, collision impact reduction, sign recognition, lane departure warning, lane keeping assist, and adaptive high-beam control. The imaging apparatuses 7c and 7d can be involved in, for example, functions such as collision prevention at the time of backward movement, collision impact reduction, and parking assistance. The imaging apparatus 7e can be involved in functions such as rear-side approach attention assistance, lane change assistance, travel assistance on narrow-width roads, and turn collision prevention assistance.

FIG. 4 is a block diagram showing an example of a sensing apparatus according to the present invention. As shown in FIG. 4, a sensing apparatus 80 includes the imaging apparatus 2a, an image processing unit 81, and an output unit 82. The image processing unit 81 is connected to the imaging apparatus 2a, and may be composed of an information processing apparatus or a computer that executes given processing on image data obtained from the imaging apparatus 2a. The output unit 82 may include, for example, a display.

As shown in FIG. 4, the output unit 82 is connected, for example, to an electronic control unit (ECU) through a communication path 85. Data generated by processing in the image processing unit 81 is sent from the output unit 82 to the ECU through the communication path 85. Examples of a communication protocol on the communication path 85 may include a controller area network (CAN), a local interconnect network (LIN), FlexRay, or Ethernet. As the communication protocol on the communication path 85, one or more of these communication protocols may be selected to be combined.

As shown in FIG. 4, the sensing apparatus 80 may include a storage unit 83. The storage unit 83 is connected, for example, to the image processing unit 81. For example, the data generated by the processing in the image processing unit 81 may be stored in the storage unit 83.

### EXAMPLES

The present invention will be described in more detail by examples. The present invention is not limited to the examples given below.

### Example 1

An amount of 4.500 g of copper acetate monohydrate and 240 g of tetrahydrofuran (THF) were mixed, and were stirred for 3 hours to obtain a copper acetate solution. To the obtained copper acetate solution was added 1.646 g of PLYSURF A208N (manufactured by DKS Co., Ltd.) which is a phosphoric acid ester compound, and the mixture was stirred for 30 minutes to obtain a solution A1.

An amount of 40 g of THF was added to 0.706 g of phenylphosphonic acid, and the mixture was stirred for 30 minutes to obtain a solution B1α. An amount of 40 g of THF was added to 4.230 g of 4-bromophenylphosphonic acid, and the mixture was stirred for 30 minutes to obtain a solution B1β. Next, the solution B1α and the solution B1β were mixed, and were stirred for 1 minute to obtain a solution mixture. An amount of 8.664 g of methyltriethoxysilane (MTES) (manufactured by Shin-Etsu Chemical Co., Ltd.; product name: KBE-13) and 2.840 g of tetraethoxysilane (TEOS) (manufactured by KISHIDA CHEMICAL Co., Ltd.; special grade) were added to the solution mixture. The resulting mixture was further stirred for 1 minute to obtain a solution B1.

The solution B1 was added to the solution A1 while the solution A1 was being stirred, and the resulting mixture was stirred at room temperature for 1 minute. To the resulting solution was then added 100 g of toluene, and the mixture was stirred at room temperature for 1 minute to obtain a solution C1. This solution C1 was put in a flask and subjected to solvent removal using a rotary evaporator (manufactured by Tokyo Rikakikai

Co., Ltd.; product code: N-1110SF) under heating by means of an oil bath (manufactured by Tokyo Rikakikai Co., Ltd.; product code: OSB-2100). The temperature of the oil bath was controlled to 105° C. Subsequently, a solution D1 having undergone the solvent removal was taken out of the flask. The solution D1 containing a light-absorbing compound including a phosphonic acid having an aryl group and a copper component was obtained in this manner.

An amount of 4.500 g of copper acetate monohydrate and 240 g of THF were mixed, and were stirred for 3 hours to obtain a copper acetate solution. Next, 2.573 g of PLYSURF A208N was added to the obtained copper acetate solution, and the mixture was stirred for 30 minutes to obtain a solution E1.

An amount of 40 g of THF was added to 2.885 g of n-butylphosphonic acid, and the mixture was stirred for 30 minutes to obtain a solution F1.

The solution F1 was added to the solution E1 while the solution E1 was being stirred, and the mixture was stirred at room temperature for 1 minute. To the resulting solution was then added 100 g of toluene, and the mixture was stirred at room temperature for 1 minute to obtain a solution G1. The solution G1 was put in a flask and subjected to solvent removal using a rotary evaporator under heating by means of an oil bath. The temperature of the oil bath was controlled to 105° C. Subsequently, a solution H1 having undergone the solvent removal was taken out of the flask. The solution H1 containing a light-absorbing compound including a phosphonic acid having an alkyl group and a copper component was obtained in this manner.

The solution D1 and the solution H1 were mixed such that the relation Cf:Cs between an amount Cf of the phosphonic acid having an aryl group and an amount Cs of the phosphonic acid having an alkyl group was 71:29 on a mass basis. Furthermore, an amount of 8.925 g of a curable resin (manufactured by Shin-Etsu Chemical Co., Ltd.; product name: KR-300), 0.089 g of a catalyst (manufactured by Shin-Etsu Chemical Co., Ltd.; product name: CAT-AC), 7.696 g of methyltriethoxysilane (MTES) (manufactured by Shin-Etsu Chemical Co., Ltd.; product name: KBE-13) as a trifunctional alkoxysilane, 4.015 g of tetraethoxysilane (TEOS) (manufactured by KISHIDA CHEMICAL Co., Ltd.; special grade) as a tetrafunctional alkoxysilane, and 3.476 g of dimethyldiethoxysilane (DMDES) (manufactured by Shin-Etsu Chemical Co., Ltd.; product name: KBE-22) as a bifunctional alkoxysilane were mixed and stirred for 30 minutes. Water was then added to the resulting liquid so that the amount of water was 700 ppm in terms of a mass ratio after mixing, without taking into account the amount of the water component included in the copper acetate monohydrate, and the mixture was stirred for 5 minutes to obtain a light-absorbing composition according to Example 1.

An amount of 0.1 g of an anti-smudge surface coating agent (manufactured by DAIKIN INDUSTRIES, LTD.; product name: OPTOOL DSX, concentration of active ingredient: 20 mass %) and 19.9 g of a hydrofluoroether-containing solution (manufactured by 3M Company; product name: Novec 7100) were mixed to obtain a mixture. This mixture was stirred for 5 minutes to prepare a fluorine treatment agent (concentration of active ingredient: 0.1 mass %).

The fluorine treatment agent was applied to one principal surface of a borosilicate glass (manufactured by SCHOTT AG; product name: D 263 T eco) having dimensions of 130 mm×100 mm×0.70 mm. After that, the glass substrate was left at room temperature for 24 hours to dry the coating film of the fluorine treatment agent. The glass surface was then wiped lightly with a dust-free cloth impregnated with Novec 7100 to remove an excess of the fluorine treatment agent. A fluorine-treated substrate was produced in this manner.

The light-absorbing composition according to Example 1 was applied with a dispenser to an 80 mm×80 mm region at a central portion of the one principal surface of the fluorine-treated substrate to form a coating film. The obtained coating film was fully dried at room temperature, and then placed in an oven. The solvent and a by-product were removed while the temperature inside the oven was increased in the range of room temperature to 45° C. over 6 hours. Moreover, removal of the solvent and the by-product was further performed while the temperature inside the oven was increased from 45° C. to 85° C. over 8 hours. After that, the reaction was fully promoted by further stepwise heating at 125° C. for 3 hours, at 150° C. for 1 hour, and at 170° C. for 3 hours. After that, post curing was performed in an environment at a temperature of 85° C. and a relative humidity of 85% for 24 hours to complete the curing reaction of the coating film. Finally, a cured product of the coating film was peeled off from the fluorine-treated substrate to obtain an optical filter in a film form according to Example 1.

### Example 2

A light-absorbing composition according to Example 2 was prepared in the same manner as in Example 1, except that the added amount of water was adjusted so that the amount of water was 1470 ppm. An optical filter according to Example 2 was obtained in the same manner as in Example 1, except that the light-absorbing composition according to Example 2 was used instead of the light-absorbing composition according to Example 1.

### Example 3

A light-absorbing composition according to Example 3 was prepared in the same manner as in Example 1, except that the added amount of water was adjusted so that the amount of water was 4370 ppm. An optical filter according to Example 3 was obtained in the same manner as in Example 1, except that the light-absorbing composition according to Example 3 was used instead of the light-absorbing composition according to Example 1.

### Example 4

A light-absorbing composition according to Example 4 was prepared in the same manner as in Example 1, except that the added amount of water was adjusted so that the amount of water was 6510 ppm. An optical filter according to Example 4 was obtained in the same manner as in Example 1, except that the light-absorbing composition according to Example 4 was used instead of the light-absorbing composition according to Example 1.

### Example 5

A transparent liquid material (composition for antireflection film) including an alkoxysilane, water, and ethanol and being a precursor for an antireflection film was produced. The composition for an antireflection film included methyltriethoxysilane (MTES) and tetraethoxysilane (TEOS) as the alkoxysilanes in a mass ratio of 4:1.

The composition for an antireflection film was applied to one surface of the optical filter according to Example 1 in a given thickness by spin coating to form a coating film, and the coating film was left to stand at room temperature for 1 minute to dry the coating film. Next, the composition for an antireflection film was applied to the other surface of the optical filter according to Example 1 in a given thickness by spin coating to form a coating film, and the coating film was left to stand at room temperature for 1 minute to dry the coating film. The coating films of precursors of the antireflection film were formed on both surfaces of the optical filter according to Example 1 in this manner. In this state, the optical filter according to Example 1 was heated at 85° C. for 1 hour to promote hydrolysis of the alkoxysilane included in the coating films and polycondensation by the silanol group formed therein to cure the coating films, thereby obtaining an optical filter having antireflection films on both surfaces.

### Comparative Example 1

A light-absorbing composition according to Comparative Example 1 was prepared in the same manner as in Example 1, except that the added amount of water was adjusted so that the amount of water was 8630 ppm. A filter according to Comparative Example 1 was obtained in the same manner as in Example 1, except that the light-absorbing composition according to Comparative Example 1 was used instead of the light-absorbing composition according to Example 1.

### Comparative Example 2

A light-absorbing composition according to Comparative Example 2 was prepared in the same manner as in Example 1, except that water was not added. An optical filter according to Comparative Example 2 was obtained in the same manner as in Example 1, except that the light-absorbing composition according to Comparative Example 2 was used instead of the light-absorbing composition according to Example 1.

### Comparative Example 3

An optical filter according to Comparative Example 3 was obtained in the same manner as in Example 1, except that the light-absorbing composition according to Comparative Example 2 was used instead of the light-absorbing composition according to Example 1 and the heating at 125° C. for 3 hours, at 150° C. for 1 hour, and at 170° C. for 3 hours was not performed.

### Transmission Spectrum

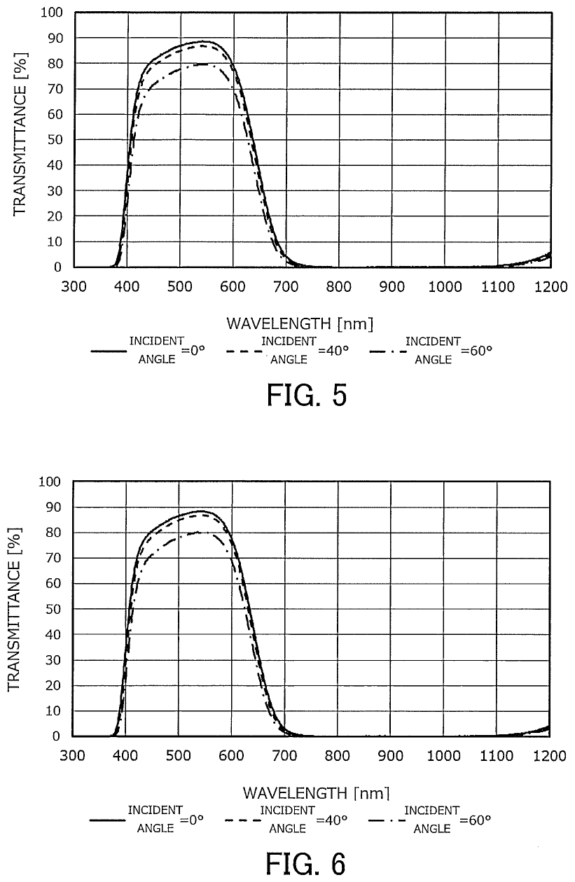

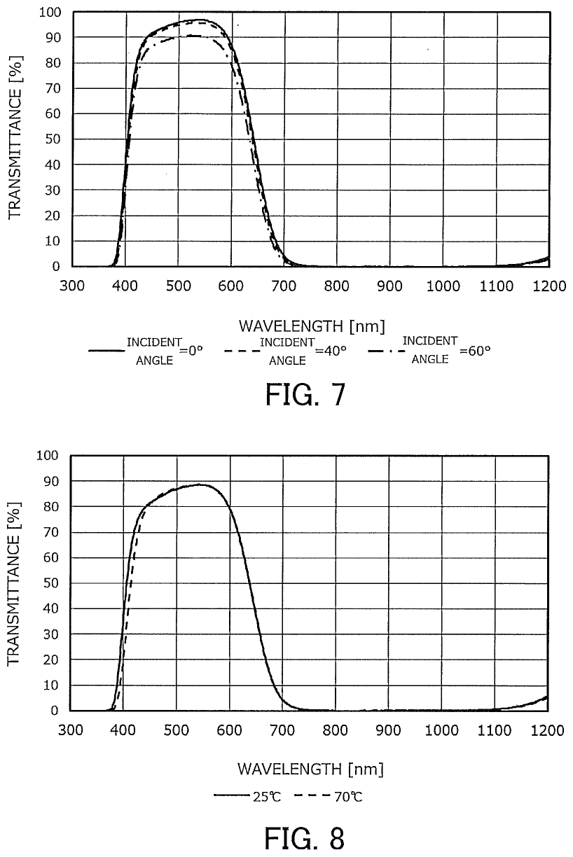

An ultraviolet-visible-near-infrared spectrophotometer V-770 manufactured by JASCO Corporation was used for measuring transmission spectra of the optical filters according to Examples and Comparative Examples. The transmission spectra were measured in the wavelength range of 300 nm to 1200 nm when light was allowed to be incident on each of the optical filters according to Examples and Comparative Examples at incident angles of 0°, 40°, and 60° at 25° C. The transmission spectrum of the optical filter was measured by fixing the optical filter inside a compact constant-temperature chamber manufactured by OPTQUEST CO., LTD. capable of adjusting and maintaining the internal temperature and by arranging the compact constant-temperature chamber in the above spectrophotometer. Table 1 shows parameters that can be obtained from the transmission spectra of the optical filters according to Examples and Comparative Examples at an incident angle of 0°. Table 2 shows parameters that can be obtained from the transmission spectra of the optical filters according to Examples 1, 4, and 5 at incident angles of 0°, 40°, and 60°. FIG. 5, FIG. 6, and FIG. 7 show transmission spectra of the optical filters according to Examples 1, 4, and 5, respectively.

The transmission spectra were then measured in the wavelength range of 300 nm to 1200 nm when light was allowed to be incident on the filters according to Examples 1 to 5 and Comparative Example 1 and the optical filters according to Comparative Examples 2 and 3 at incident angles of 0°, 40°, and 60° at 70° C. FIG. 8 shows transmission spectra of the optical filter according to Example 1 at an incident angle of 0° at 25° C. and 70° C. Table 1 shows parameters that can be obtained from the transmission spectra.

### Reflection Spectrum

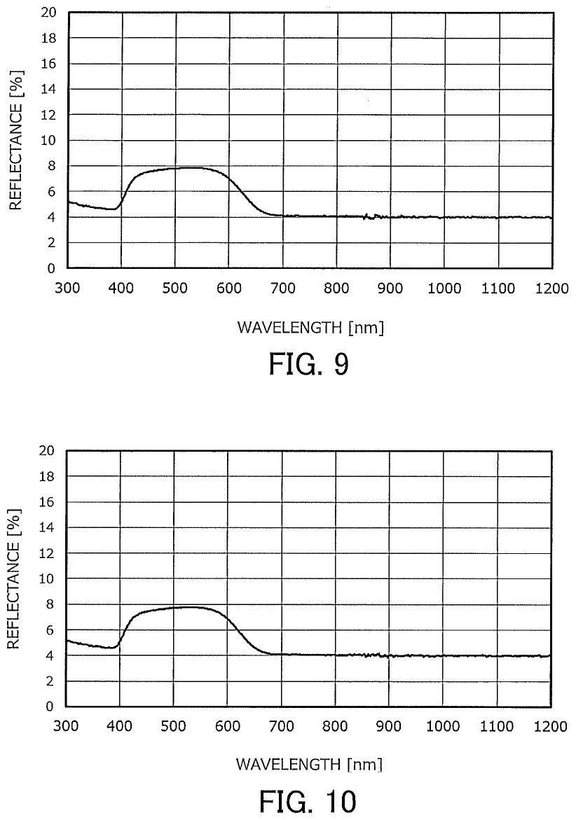

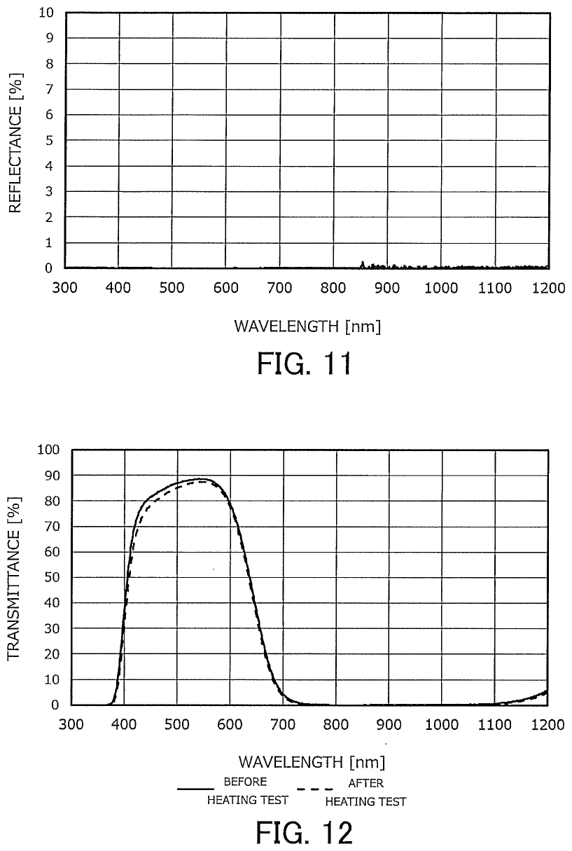

An ultraviolet-visible-near-infrared spectrophotometer V-770 manufactured by JASCO Corporation was used for measuring reflection spectra of the optical filters. The reflection spectra were measured in the wavelength range of 300 nm to 1200 nm when light was allowed to be incident on each of the optical filters according to Examples and Comparative Examples at an incident angle of 5° at 25° C. The reflection spectrum was also measured using a compact constant-temperature chamber in the same manner as in the measurement of the transmission spectrum. FIG. 9, FIG. 10, and FIG. 11 show reflection spectra of the optical filters according to Examples 1, 4, and 5, respectively. Table 1 shows parameters obtained from the obtained reflection spectra.

### Thickness

Thicknesses of the optical filters according to Examples and Comparative Examples were measured using a laser displacement meter LK-H008 manufactured by Keyence Corporation. Table 1 shows the results.

### Haze

The haze of each of the optical filters according to Examples and Comparative Examples was measured in accordance with Japanese Industrial Standards JIS K 7136:2000 using a haze meter HM-65L2 manufactured by MURAKAMI COLOR RESEARCH LABORATORY CO., LTD.

### Heating Test

After the transmission spectra, the reflection spectra, the thicknesses, and the hazes were measured as described above, each of the optical filters according to Examples and Comparative Examples was placed in a constant-temperature chamber in which the temperature in the chamber was around room temperature (18° C. to 28° C.), and the temperature inside the constant-temperature chamber was increased to 125° C. and left to stand for 200 hours. After that, the temperature was naturally decreased until the temperature inside the constant-temperature chamber reached room temperature, and the optical filter was taken out. An economical forced convection oven DKM400 supplied by AS ONE Corporation was used as the constant-temperature chamber.

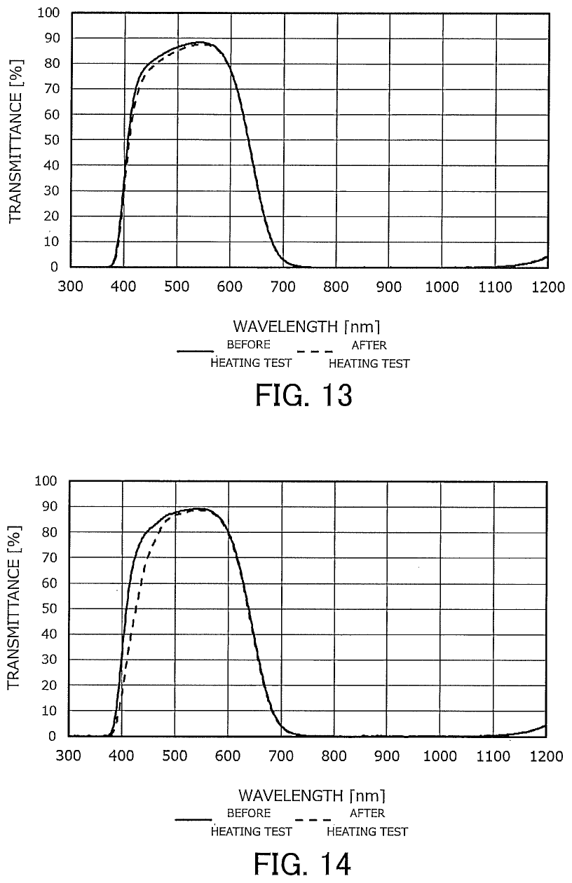

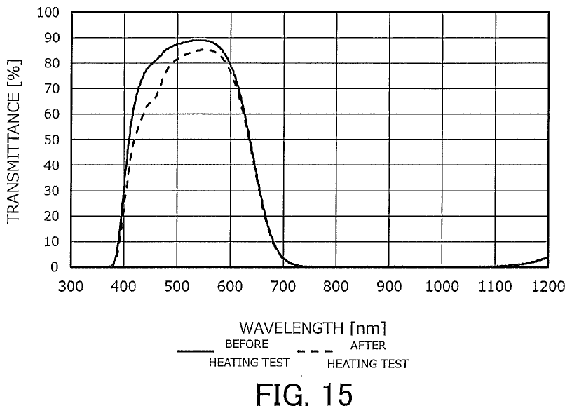

Each of the optical filters was then taken out of the constant-temperature chamber, and transmission spectra were measured in the wavelength range of 300 nm to 1200 nm when light was allowed to be incident on each of the optical filters according to Examples and Comparative Examples at incident angles of 0°, 40°, and 60° at 25° C. FIG. 12, FIG. 13, FIG. 14, and FIG. 15 show transmission spectra (incident angle of 0° and measurement temperature of 25° C.) before and after the heating test according to Example 1, Example 4, Comparative Example 2, and Comparative Example 3,respectively. Values of the following parameters were identified in the transmission spectra of the optical filters at 25° C. before the heating test and in the transmission spectra of the optical filters at 25° C. after the heating test. Table 3 shows the results.

A wavelength which lies in the wavelength range of 350 nm to 450 nm and at which the transmittance is 50%

A wavelength which lies in the wavelength range of 600 nm to 700 nm and at which the transmittance is 50%

A wavelength which lies in the wavelength range of 600 nm to 700 nm and at which the transmittance is 20%

An average transmittance in the wavelength range of 400 nm to 450 nm

An average transmittance in the wavelength range of 450 nm to 600 nm

As shown in Table 1, the transmission spectra of the optical filters according to Examples at an incident angle of 0° at 25° C. before the heating test satisfied the above requirements (i) to (iv). Moreover, as shown in Table 3, for example, in the transmission spectra of the optical filters according to Examples 1 and 4 at an incident angle of 0° at 25° C. before and after the heating test, the absolute value of the difference between the wavelengths which lie in the wavelength range of 350 nm to 450 nm and at which the transmittance is 50% was 8 nm or less. Meanwhile, in the transmission spectra of the optical filters according to Comparative Examples 2 and 3 at an incident angle of 0° at 25° C. before and after the heating test, the absolute value of the difference between the wavelengths which lie in the wavelength range of 350 nm to 450 nm and at which the transmittance is 50% was more than 8 nm.

Moreover, as shown in Table 1, all the haze values of the optical filters according to Examples before the heating test are less than 0.5%, and are suitable as optical filters to be installed in an imaging apparatus and the like. Meanwhile, since the amount of water added to the filter according to Comparative Example 1 is large, the haze thereof is more than 0.5, indicating that the filter is not suitable as an optical filter to be installed in an imaging apparatus.

TABLE 1

| | | | | | | | Comparative | | |
|---|---|---|---|---|---|---|---|---|---|
| | Example | | | | | | Example | | |
| | 1 | | 2 | 3 | 4 | 5 | 1 | 2 | 3 |
| Measurement temperature | 25° C. | 70° C. | 25° C. | 25° C. | 25° C. | 25° C. | 25° C. | 25° C. | 25° C. |
| Average transmittance in | 0.1 | 0.1 | 0.1 | 0.1 | 0.1 | 0.1 | 0.1 | 0.1 | 0.1 |
| wavelength range of 300 nm | | | | | | | | | |
| to 380 nm [%] | | | | | | | | | |
| Average transmittance in | 69.0 | 61.2 | 69.0 | 68.9 | 67.4 | 77.9 | 65.5 | 65.7 | 64.1 |
| wavelength range of 400 nm | | | | | | | | | |
| to 450 nm [%] | | | | | | | | | |
| Average transmittance in | 86.1 | 86.2 | 86.2 | 86.4 | 85.5 | 94.7 | 85.4 | 86.7 | 86.1 |
| wavelength range of 450 nm | | | | | | | | | |
| to 600 nm [%] | | | | | | | | | |
| Average transmittance in | 2.4 | 2.5 | 1.8 | 2 | 1.6 | 2.2 | 1.7 | 2.3 | 1.9 |
| wavelength range of 700 nm | | | | | | | | | |
| to 725 nm [%] | | | | | | | | | |
| Average transmittance in | 0.1 | 0.1 | 0.1 | 0.1 | 0.1 | 0.1 | 0.1 | 0.1 | 0.1 |
| wavelength range of 900 nm | | | | | | | | | |
| to 950 nm [%] | | | | | | | | | |
| Average transmittance in | 0.5 | 0.4 | 0.3 | 0.4 | 0.3 | 0.3 | 0.1 | 0.3 | 0.2 |
| wavelength range of 950 nm | | | | | | | | | |
| to 1150 nm [%] | | | | | | | | | |
| Transmittance at wavelength | 37.0 | 20.6 | 35.9 | 35.0 | 34.1 | 40.5 | 28.4 | 31.6 | 30.7 |
| of 400 nm [%] | | | | | | | | | |
| Wavelength which lies in | 406 | 414 | 407 | 407 | 408 | 404 | 410 | 409 | 410 |
| wavelength range of 350 nm | | | | | | | | | |
| to 450 nm and at which | | | | | | | | | |
| transmittance is 50% [nm] | | | | | | | | | |
| Wavelength which lies in | 638 | 637 | 636 | 637 | 635 | 642 | 638 | 639 | 637 |
| wavelength range of 600 nm | | | | | | | | | |
| to 700 nm and at which | | | | | | | | | |
| transmittance is 50% [nm] | | | | | | | | | |
| Wavelength which lies in | 669 | 668 | 666 | 668 | 665 | 670 | 667 | 669 | 667 |
| wavelength range of 600 nm | | | | | | | | | |
| to 700 nm and at which | | | | | | | | | |
| transmittance is 20% [nm] | | | | | | | | | |
| Maximum of reflectance in | 5.3 | — | — | — | 5.2 | 0.1 | — | — | — |
| wavelength range of 300 nm | | | | | | | | | |
| to 400 nm [%] | | | | | | | | | |
| Average reflectance in | 4.1 | — | — | — | 4.1 | 0.1 | — | — | — |
| wavelength range of 800 nm | | | | | | | | | |
| to 1150 nm [%] | | | | | | | | | |
| Average reflectance in | 7.7 | — | — | — | 7.6 | 0.1 | — | — | — |
| wavelength range of 450 nm | | | | | | | | | |
| to 600 nm [%] | | | | | | | | | |
| Haze [%] | 0.24 | 0.24 | 0.24 | 0.28 | 0.39 | 0.23 | 0.61 | 0.21 | 0.24 |
| Thickness [μm] | 195 | 195 | 198 | 198 | 205 | 195 | 210 | 201 | 200 |

TABLE 2

| | | | Wavelength | Wavelength | Wavelength |
|---|---|---|---|---|---|
| | | | which lies | which lies | which lies |
| | | | in wavelength | in wavelength | in wavelength |
| | | | range of 350 | range of 600 | range of 600 |
| | | | nm to 450 nm | nm to 700 nm | nm to 700 nm |
| | | Incident | and at which | and at which | and at which |
| | Measurement | angle | transmittance | transmittance | transmittance |
| | temperature | [°] | is 50% [nm] | is 50% [nm] | is 20% [nm] |
| Example | 25° C. | 0 | 406 | 638 | 669 |
| 1 | | 40 | 409 | 635 | 665 |
| | | 60 | 413 | 628 | 660 |
| Example | 25° C. | 0 | 408 | 635 | 665 |
| 4 | | 40 | 410 | 632 | 662 |
| | | 60 | 414 | 626 | 657 |
| Example | 25° C. | 0 | 404 | 642 | 670 |
| 5 | | 40 | 406 | 639 | 667 |
| | | 60 | 408 | 634 | 663 |

TABLE 3

| | | | Wavelength | Wavelength | Wavelength | | |
|---|---|---|---|---|---|---|---|
| | | | which lies in | which lies in | which lies in | | |
| | | | wavelength | wavelength | wavelength | Average | Average |
| | | | range of 350 | range of 600 | range of 600 | transmittance | transmittance |
| | | | nm to 450 nm | nm to 700 nm | nm to 700 nm | in wavelength | in wavelength |
| | | 125° C. × | and at which | and at which | and at which | range of 400 | range of 450 |
| | Measurement | 200 hours | transmittance | transmittance | transmittance | nm to 450 nm | nm to 600 nm |
| | temperature | (heating test) | is 50% [nm] | is 50% [nm] | is 20% [nm] | [%] | [%] |
| Example 1 | 25° C. | Before | 406 | 638 | 669 | 69.0 | 86.1 |
| | | heating test | | | | | |
| | | After | 410 | 636 | 666 | 64.0 | 84.4 |
| | | heating test | | | | | |
| Example 4 | 25° C. | Before | 408 | 635 | 665 | 67.4 | 85.5 |
| | | heating test | | | | | |
| | | After | 410 | 635 | 665 | 63.5 | 84.4 |
| | | heating test | | | | | |
| Comparative | 25° C. | Before | 409 | 639 | 669 | 65.7 | 86.7 |
| Example 2 | | heating test | | | | | |
| | | After | 427 | 638 | 668 | 46.9 | 85.0 |
| | | heating test | | | | | |
| Comparative | 25° C. | Before | 410 | 637 | 667 | 64.1 | 86.1 |
| Example 3 | | heating test | | | | | |
| | | After | 420 | 636 | 666 | 50.6 | 80.1 |
| | | heating test | | | | | |

1. An optical filter comprising:
a light-absorbing compound; and
a resin,
wherein the optical filter has a first transmission spectrum at an incident angle of 0° at 25° C. before a heating test in which the optical filter is heated at 125° C. for 200 hours, the first transmission spectrum satisfying the following requirements (i), (ii), (iii), and (iv),
wherein the optical filter has a second transmission spectrum at an incident angle of 0° at 25° C. after the heating test, and
wherein an absolute value of a difference between a wavelength λ_{1-UV}^{25° C.} which lies in a wavelength range of 350 nm to 450 nm and at which a transmittance is 50% in the first transmission spectrum and a wavelength λ_{2-UV}^{25° C.} which lies in the wavelength range of 350 nm to 450 nm and at which the transmittance is 50% in the second transmission spectrum is 8 nm or less:
(i) an average transmittance in a wavelength range of 300 nm to 380 nm is 1% or less;
(ii) an average transmittance in a wavelength range of 450 nm to 600 nm is 80% or more;
(iii) an average transmittance in a wavelength range of 700 nm to 725 nm is 10% or less; and
(iv) an average transmittance in a wavelength range of 950 nm to 1150 nm is 5% or less.

2. The optical filter according to claim 1, wherein the optical filter has a reflection spectrum at an incident angle of 5° at a temperature of 25° C., and the reflection spectrum satisfies the following requirements (I) and (II):
(I) a maximum of a reflectance in a wavelength range of 300 nm to 400 nm is 8% or less; and
(II) an average reflectance in a wavelength range of 800 nm to 1150 nm is 10% or less.

3. The optical filter according to claim 1,
wherein the optical filter has a third transmission spectrum at an incident angle of 0° at 70° C., and
wherein an absolute value of a difference between the wavelength λ_{1-UV}^{25° C.} which lies in the wavelength range of 350 nm to 450 nm and at which the transmittance is 50% in the first transmission spectrum and a wavelength λUV^{70° C.} which lies in the wavelength range of 350 nm to 450 nm and at which the transmittance is 50% in the third transmission spectrum is 10 nm or less.

4. The optical filter according to claim 1,
wherein the optical filter has a third transmission spectrum at an incident angle of 0° at 70° C., and
wherein an absolute value of a difference between a wavelength λ_{1-IR}^{25° C.} which lies in a wavelength range of 600 nm to 700 nm and at which the transmittance is 50% in the first transmission spectrum and a wavelength λ_{IR}^{70° C.} which lies in the wavelength range of 600 nm to 700 nm and at which the transmittance is 50% in the third transmission spectrum is 10 nm or less.

5. The optical filter according to claim 1,
wherein the optical filter has a third transmission spectrum at an incident angle of 0° at 70° C., and
wherein an absolute value of a difference between a transmittance T₄₀₀^{25°0 C.} at a wavelength of 400 nm in the first transmission spectrum and a transmittance T₄₀₀^{70° C.} at the wavelength of 400 nm in the third transmission spectrum is 20% or less.

6. The optical filter according to claim 1,
wherein an absolute value of a difference between a wavelength λ_{1-IR}^{25° C.} which lies in a wavelength range of 600 nm to 700 nm and at which the transmittance is 50% in the first transmission spectrum and a wavelength λ_{2-IR}^{25° C.} which lies in the wavelength range of 600 nm to 700 nm and at which the transmittance is 50% in the second transmission spectrum is 5 nm or less.

7. The optical filter according to claim 1, wherein an absolute value of a difference between a wavelength λ₁₋₂₀^{25° C.} which lies in a wavelength range of 600 nm to 700 nm and at which the transmittance is 20% in the first transmission spectrum and a wavelength λ₂₋₂₀^{25° C.} which lies in the wavelength range of 600 nm to 700 nm and at which the transmittance is 20% in the second transmission spectrum is 5 nm or less.

8. The optical filter according to claim 1, wherein an absolute value of a difference between an average transmittance T₁₋₄₅₀^{25° C.} in a wavelength range of 400 nm to 450 nm in the first transmission spectrum and an average transmittance T₂₋₄₅₀^{25° C.} in the wavelength range of 400 nm to 450 nm in the second transmission spectrum is 8% or less.

9. The optical filter according to claim 1, wherein an absolute value of a difference between an average transmittance T_{1-VIS}^{25° C.} in a wavelength range of 450 nm to 600 nm in the first transmission spectrum and an average transmittance T_{2-VIS}^{25° C.} in the wavelength range of 450 nm to 600 nm in the second transmission spectrum is 3% or less.

10. The optical filter according to claim 1, wherein the optical filter has a haze of 0.5% or less.

11. A light-absorbing composition comprising:
a light-absorbing compound;
a curable resin;
at least one selected from the group consisting of an alkoxysilane and a hydrolysate of an alkoxysilane; and
water.

12. The light-absorbing composition according to claim 11, wherein an amount of the water in the light-absorbing composition is 700 parts per million (ppm) to 7000 ppm on a mass basis.

13. A method for manufacturing an optical filter, comprising causing the light-absorbing composition of claim 11 to have the curable resin cured by a step including the following heating steps (a), (b), (c), and (d):
(a) heating at a first heating temperature included in a temperature range of room temperature to 60° C. for 2 hours or more;
(b) heating at a second heating temperature included in a temperature range of the first heating temperature to 100° C. for 2 hours or more;
(c) heating at a third heating temperature included in a temperature range of the second heating temperature to 140° C. for 2 hours or more; and
(d) heating at a fourth heating temperature included in a temperature range of the third heating temperature to 200° C. for 1 hour or more.

14. An imaging apparatus comprising the optical filter of claim 1.

15. A sensing apparatus comprising:
an imaging apparatus; and
a computer connected to the imaging apparatus,
wherein the imaging apparatus includes the optical filter of claim 1.

16. A sensing method comprising executing, by a computer, given processing on image data obtained by an imaging apparatus,
wherein the imaging apparatus includes the optical filter of claim 1.
